(19) United States
(12) Patent Application Publication
(10) Pub. No.: US 2026/0244224 A1
(43) Pub. Date: Aug. 20, 2026

(54) CONTROL DEVICE, CONTROL METHOD, AND NON-TRANSITORY COMPUTER-READABLE STORAGE MEDIUM

(71) Applicant: NEC Corporation, Tokyo (JP)

(72) Inventors: Yoshihiro ASAKAWA, Tokyo (JP); Kenichi KEYAKI, Tokyo (JP); Katsuo MIYAMOTO, Tokyo (JP); Kohei OKADA, Tokyo (JP); Kentaro ISHIWATA, Tokyo (JP); Akiyo SUZUKI, Tokyo (JP); Hiroyuki KAKINUMA, Tokyo (JP)

(73) Assignee: NEC Corporation, Tokyo (JP)

(21) Appl. No.: 19/161,799

(22) PCT Filed: Feb. 26, 2024
(86) PCT No.: PCT/JP2024/006714

§ 371 Date: Sep. 3, 2025

(30) Foreign Application Priority Data
Mar. 15, 2023 (JP) 2023-040582

(51) Int. Cl. G05D 1/695; G05B 13/02; G05D 109/25; G08G 5/57; G08G 5/76

(52) U.S. Cl. CPC G05D 1/695; G05B 13/027; G08G 5/57; G08G 5/76; G05D 2109/254

(57) ABSTRACT

A control device according to one embodiment of the present disclosure comprises: an acquisition means for acquiring function information indicating a measurement function of each of a plurality of mobile bodies; a determination means for determining, on the basis of the functional information, the role of one of the plurality of mobile bodies having a measurement function that meets a predetermined standard as a lead aircraft, and determining the roles of the other mobile bodies as wingmen; and a control means for performing control to cause the plurality of mobile bodies to be grouped as a formation, in accordance with the determined roles.

### TECHNICAL FIELD

The present disclosure relates to a technique for controlling a mobile body.

### BACKGROUND ART

A service using a mobile body such as a drone is supposed to be provided. For example, when delivering supplies using a mobile body, administration of a large number of mobile bodies is conceivable.

In connection with the control of a large number of mobile bodies, PTL 1 discloses a technique for changing the shape of formation. Specifically, a technique is disclosed that selects one aircraft from a formation displayed on a display, based on a user operation, and when a position within a movable range is selected by a user, enables to transmit, to the one aircraft, a control signal for moving the one aircraft to the selected position.

PTL 2 discloses a technique that, in a case where a flight airspace and a flight direction of a plurality of drones have predetermined commonality, causes the plurality of drones to share the flight airspace on condition that formation flight for controlling mutual distances is performed. At this time, in the technique disclosed in PTL 2, arrangement for placing the drones in the order of leaving the formation flight is determined as arrangement at the time of the formation flight.

### CITATION LIST

### Patent Literature

PTL 1: JP 2017-222254 A
PTL 2: WO 2019/054056 A1

### SUMMARY OF INVENTION

### Technical Problem

When the mobile bodies perform a formation flight, the mobile bodies in the formation have roles such as a lead aircraft and a wingman. As an example, the lead aircraft navigates to a destination, using various functions, and the wingman follows the lead aircraft. Here, depending on the situation, a mobile body that is not suitable for a role may sometimes be involved. For example, in this example, a mobile body that does not have a function for navigating to a destination is not suitable for the lead aircraft. That is, when the mobile bodies are caused to perform a formation flight, its roles have to be appropriately assigned.

The present disclosure has been made in view of the above problems, and an object of the present disclosure is to provide a control device and the like capable of assisting in control of a plurality of mobile bodies.

### Solution to Problem

A control device according to an aspect of the present disclosure includes an acquisition means for acquiring function information indicating measurement functions provided in each of a plurality of mobile bodies, a determination means for determining a role of one mobile body having a measurement function meeting a predetermined criterion, among the plurality of mobile bodies, as a lead aircraft, and determining roles of other mobile bodies as wingmen, based on the function information, and a control means for performing control to cause the plurality of mobile bodies to form a formation in accordance with the determined roles.

A mobile body according to an aspect of the present disclosure includes an acquisition means for acquiring function information indicating measurement functions provided in each of a plurality of mobile bodies when the plurality of mobile bodies forms a formation, a determination means for determining the mobile body as a lead aircraft when the mobile body has a measurement function meeting a predetermined criterion, and determining the mobile body as a wingman when the mobile body does not have a measurement function meeting the predetermined criterion, based on the function information, and a control means for controlling the mobile body in accordance with a determined role.

A control device according to an aspect of the present disclosure includes acquiring function information indicating measurement functions provided in each of a plurality of mobile bodies, determining a role of one mobile body having a measurement function meeting a predetermined criterion, among the plurality of mobile bodies, as a lead aircraft, and determining roles of other mobile bodies as wingmen, based on the function information, and performing control to cause the plurality of mobile bodies to form a formation in accordance with the determined roles.

A storage medium according to an aspect of the present disclosure stores a program for causing a computer to execute, when acquiring function information indicating measurement functions provided in each of a plurality of mobile bodies, a process of determining a role of one mobile body having a measurement function meeting a predetermined criterion, among the plurality of mobile bodies, as a lead aircraft, and determining roles of other mobile bodies as wingmen, based on the function information, and a process of performing control to cause the plurality of mobile bodies to form a formation in accordance with the determined roles.

### Advantageous Effects of Invention

According to the present disclosure, assistance in control of a plurality of mobile bodies is enabled.

### BRIEF DESCRIPTION OF DRAWINGS

FIG. 1 is a diagram schematically illustrating an example of a configuration including a control device according to a first example embodiment.

FIG. 2 is a block diagram illustrating an example of a functional configuration of the control device according to the first example embodiment.

FIG. 3 is a flowchart explaining an example of an operation of the control device according to the first example embodiment.

FIG. 4 is a block diagram illustrating an example of a configuration of a mobile body control system according to a second example embodiment.

FIG. 5 is a diagram illustrating an example of a mobile body according to the second example embodiment.

FIG. 6 depicts an example of function information according to the second example embodiment.

FIG. 7 is a flowchart explaining an example of an operation of a control device according to the second example embodiment.

FIG. 8 is a block diagram illustrating an example of a configuration of a mobile body control system according to a third example embodiment.

FIG. 9 is a diagram schematically illustrating an example of mobile bodies forming a formation according to the third example embodiment.

FIG. 10 is a flowchart explaining an example of an operation of a control device according to the third example embodiment.

FIG. 11 is a block diagram illustrating an example of a configuration of a mobile body control system according to a fourth example embodiment.

FIG. 12 is a diagram schematically illustrating an example of formation navigation information according to the fourth example embodiment.

FIG. 13 is a diagram schematically illustrating an example of mobile body navigation information according to the fourth example embodiment.

FIG. 14 is a diagram explaining an example of a situation in which a mobile body joins a formation according to the fourth example embodiment.

FIG. 15 is a diagram explaining an example of a situation in which a mobile body leaves a formation according to the fourth example embodiment.

FIG. 16 is a flowchart explaining a first example of an operation of a control device according to the fourth example embodiment.

FIG. 17 is a flowchart explaining a second example of an operation of the control device according to the fourth example embodiment.

FIG. 18 is a diagram schematically illustrating an example of a configuration including mobile bodies according to a fifth example embodiment.

FIG. 19 is a block diagram illustrating an example of a configuration of a mobile body according to the fifth example embodiment.

FIG. 20 is a flowchart explaining a first example of an operation of the mobile body according to the fifth example embodiment.

FIG. 21 is a flowchart explaining a second example of an operation of the mobile body according to the fifth example embodiment.

FIG. 22 is a flowchart explaining a third example of an operation of the mobile body according to the fifth example embodiment.

FIG. 23 is a flowchart explaining a fourth example of an operation of the mobile body according to the fifth example embodiment.

FIG. 24 is a block diagram illustrating an example of a functional configuration of a mobile body according to a third modification.

FIG. 25 is a block diagram illustrating an example of a hardware configuration of a computer device that implements control devices and mobile bodies according to the first, second, third, fourth, and fifth example embodiments of the present disclosure.

### EXAMPLE EMBODIMENT

Hereinafter, example embodiments of the present disclosure will be described with reference to the drawings.

### First Example Embodiment

An outline of a control device according to a first example embodiment will be described.

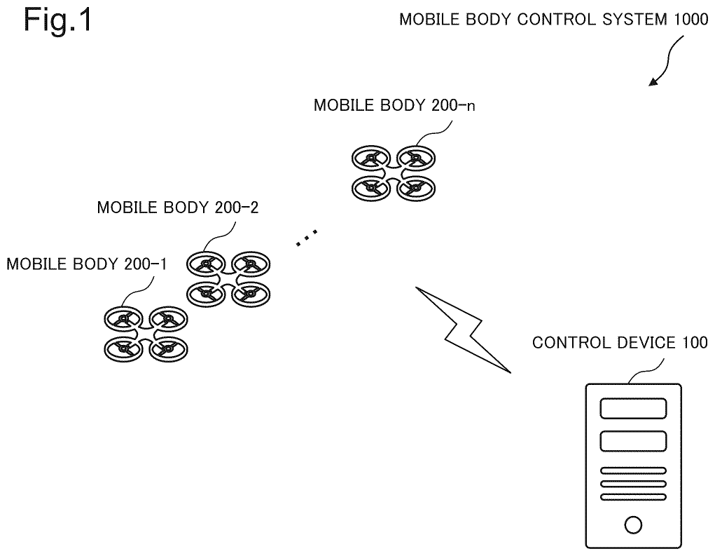

FIG. 1 is a diagram schematically illustrating an example of a configuration including a control device 100. A mobile body control system 1000 includes at least the control device 100. In the example in FIG. 1, the mobile body control system 1000 includes the control device 100 and mobile bodies 200-1, 200-2, . . . , 200-n (n is a natural number equal to or more than two). In the present disclosure, in a case where the mobile bodies 200-1, 200-2, . . . , and 200-n are not distinguished from one another, they will be simply referred to as “mobile bodies 200”. The control device 100 is connected to the mobile bodies 200 via a wireless or wired network in such a way that communication is allowed.

The mobile body 200 is, for example, a manned or unmanned aircraft such as a multicopter (also called a multi-rotor helicopter, a multi-rotor, or the like). A multicopter that is not boarded by a person may sometimes be called an unmanned aerial vehicle (UAV), a small unmanned vehicle, or a drone. In the present disclosure, an example in which the mobile body 200 is an aircraft will be mainly described, but the mobile body 200 is not limited to this example. For example, the mobile body 200 may be an unmanned ship or the like that can be remotely controlled.

The mobile body 200 has various functions. More specifically, the mobile body 200 has one or more measurement functions. An example of the measurement functions is an imaging function. For example, the mobile body 200 generates a captured image by imaging the surroundings. The measurement function may be a positioning function for position information. For example, the mobile body 200 measures the position information on the mobile body 200 by receiving a signal from a satellite. The measurement function may be a distance measurement function. For example, the mobile body 200 measures a distance to an object. The measurement functions may be functions implemented by various sensors, radars, and the like. The functions provided in the mobile body 200 are not limited to these examples.

The mobile body 200 can fly in formation. The formation involves roles. Specifically, the formation includes a lead aircraft and a wingman. For example, the lead aircraft leads the wingman to navigate to a destination. The wingman flies, for example, following the lead aircraft or another wingman. That is, the wingman may sometimes fly in accordance with the navigation of the lead aircraft. In such a case, the lead aircraft may sometimes be responsible for a task of ensuring safety. For example, the lead aircraft measures the position information on the lead aircraft to navigate in such a way as not to deviate from a predefined navigation route. For example, the lead aircraft measures a distance to a surrounding building or the like and navigates in such a way that the distance to the building or the like is not too close. For example, the lead aircraft images the surroundings to detect an obstacle and navigates in such a way as to avoid the obstacle. In this case, the lead aircraft is required to have a position information positioning function, a distance measurement function, and an imaging function as measurement functions for ensuring safety. The tasks of the lead aircraft and the wingman in the formation are not limited to these examples. For example, the wingman may sometimes be required to have a measurement function for monitoring the surroundings.

The control device 100 is, for example, a server. The control device 100 may be implemented as a cloud server. The control device 100 may be a device owned by an administrator of the mobile body 200. The control device 100 may also be a device owned by a service provider that provides a service using the mobile body 200. The control device 100 can acquire information regarding the mobile body 200. The control device 100 controls the mobile body 200.

As described above, the functions required for the mobile body 200 may be different in some cases depending on the tasks of the lead aircraft and the wingman. The control device 100 determines a role in a formation for each of a plurality of mobile bodies 200 forming one formation.

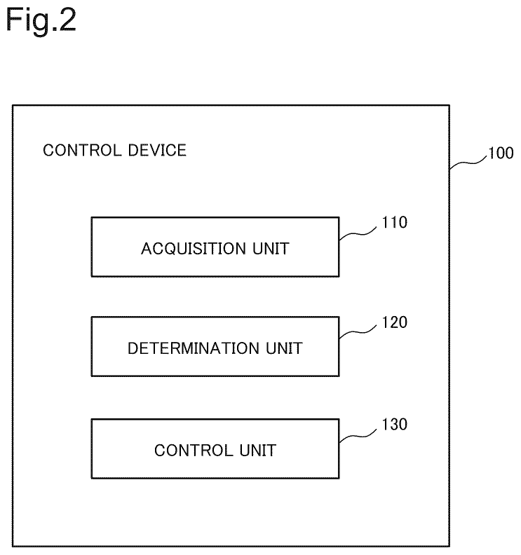

Next, an example of a functional configuration of the control device 100 will be described. FIG. 2 is a block diagram illustrating an example of a functional configuration of the control device 100. As illustrated in FIG. 2, the control device 100 includes an acquisition unit 110, a determination unit 120, and a control unit 130.

The acquisition unit 110 acquires function information on the plurality of mobile bodies 200. The function information is information for each mobile body 200. The function information indicates a measurement function provided in the mobile body 200. For example, the acquisition unit 110 may acquire the function information from each of the plurality of mobile bodies 200. In a case where the function information on each of the plurality of mobile bodies 200 is stored in a storage device (not illustrated), the acquisition unit 110 may acquire the function information from the storage device. In this case, the storage device may be a device included in the control device 100 or an external device connected to the control device 100 in such a way that communication is allowed.

In this manner, the acquisition unit 110 acquires the function information indicating measurement functions provided in each of the plurality of mobile bodies 200. The acquisition unit 110 is an example of an acquisition means.

The determination unit 120 determines the roles of the plurality of mobile bodies 200, based on the function information. Specifically, the determination unit 120 determines the roles in accordance with a predetermined criterion required for a role in the formation. The predetermined criterion may be a criterion relating to a function required for a role. That is, the determination unit 120 may determine the role in accordance with whether the mobile body 200 has a function required for the role. For example, in a case where a predetermined measurement function is required for the lead aircraft, the determination unit 120 determines one mobile body having the predetermined measurement function, among the plurality of mobile bodies 200, as a lead aircraft, based on the function information.. Then, the determination unit 120 determines the other mobile bodies as wingmen.

The predetermined criterion may be a criterion relating to performance of a function required for a role. That is, the determination unit 120 may determine the role in accordance with performance of a function provided in the mobile body 200. At this time, the determination unit 120 may compare the function information to determine a mobile body having a function with better performance, among the plurality of mobile bodies 200, as a lead aircraft. For example, in a case where the imaging function is required for the lead aircraft, the determination unit 120 may determine, as a lead aircraft, a mobile body capable of imaging with a highest number of pixels or a mobile body with a highest zoomable magnification, among the plurality of mobile bodies 200. The approach for determining the roles is not limited to these examples.

In this manner, the determination unit 120 determines, among the plurality of mobile bodies 200, the role of one mobile body having a measurement function meeting a predetermined criterion, as a lead aircraft, and the roles of the other mobile bodies as wingmen, based on the function information. The determination unit 120 is an example of a determination means.

The control unit 130 controls the mobile body 200. Specifically, the mobile body 200 is controlled in accordance with the role determined by the determination unit 120. For example, the control unit 130 performs control to cause a mobile body determined as a lead aircraft to navigate to a destination. For example, the control unit 130 performs control to cause the mobile body determined as a wingman to fly following the lead aircraft. At this time, for example, the control unit 130 may perform control to cause a mobile body determined as a wingman to fly following another wingman.

In this manner, the control unit 130 performs control to cause the plurality of mobile bodies to form a formation in accordance with the determined roles. The control unit 130 is an example of a control means.

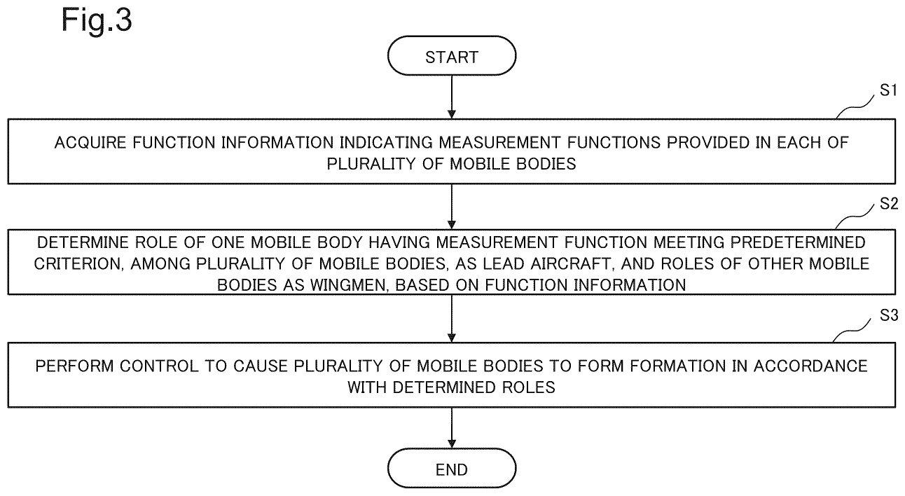

Next, an example of an operation of the control device 100 will be described with reference to FIG. 3. In the present disclosure, each step of the flowcharts is represented using a number given to each step, such as “S1”.

FIG. 3 is a flowchart explaining an example of an operation of the control device. The acquisition unit 110 acquires the function information indicating measurement functions provided in each of the plurality of mobile bodies 200 (S1). The determination unit 120 determines, among the plurality of mobile bodies 200, the role of one mobile body having a measurement function meeting a predetermined criterion, as a lead aircraft, and the roles of the other mobile bodies as wingmen, based on the function information (S2). The control unit 130 performs control to cause the plurality of mobile bodies to form a formation in accordance with the determined roles (S3).

As described above, the control device 100 of the first example embodiment acquires the function information indicating measurement functions provided in each of the plurality of mobile bodies 200. The control device 100 determines, among the plurality of mobile bodies 200, the role of one mobile body having a measurement function meeting a predetermined criterion, as a lead aircraft, and the roles of the other mobile bodies as wingmen, based on the function information. Then, the control device 100 performs control to cause the plurality of mobile bodies to form a formation in accordance with the determined roles.

When the mobile bodies form a formation, roles such as the lead aircraft and the wingman may sometimes be set. At this time, a required measurement function may sometimes be defined in accordance with the task of the lead aircraft or the wingman. For example, in such a case, the control device 100 can appropriately assign the role, based on the function information indicating the measurement function. That is, the control device 100 can assist in control of a plurality of mobile bodies.

### Second Example Embodiment

Next, a control device according to a second example embodiment will be described. In the second example embodiment, another example relating to the control device 100 described in the first example embodiment will be further described. The description of content that is duplicate of that of the first example embodiment will be partially omitted.

### Details of Mobile Body Control System 1000

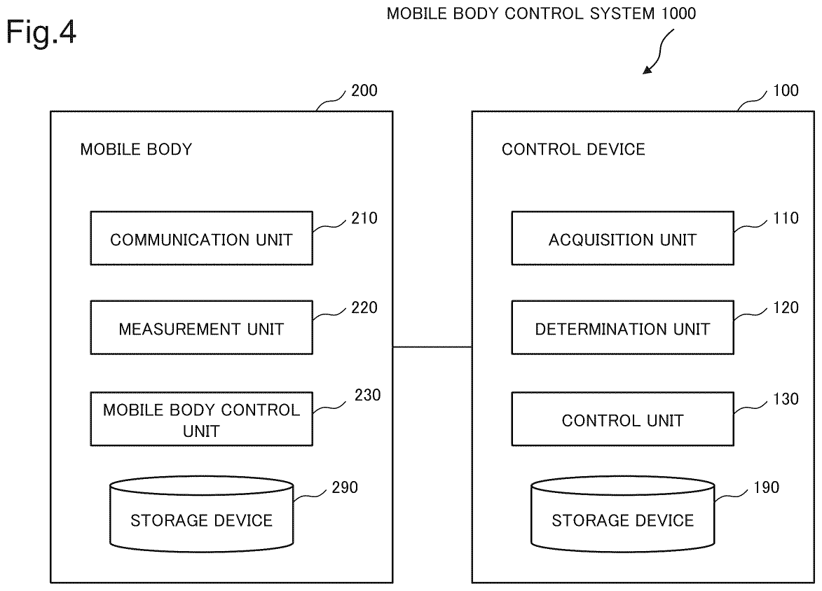

FIG. 4 is a block diagram illustrating an example of a configuration of a mobile body control system 1000.

A mobile body 200 includes a communication unit 210, a measurement unit 220, and a mobile body control unit 230. The mobile body 200 further includes a storage device 290.

The communication unit 210 communicates with an external device. Specifically, the communication unit 210 communicates with another mobile body 200 and a control device 100. For example, the communication unit 210 transmits the function information on its host mobile body to the control device 100. The communication unit 210 may also transmit information measured by the measurement unit 220, the measurement time, and the like to the control device 100. Furthermore, the communication unit 210 may receive control information from the control device 100.

The measurement unit 220 is responsible for various measurement functions. The measurement unit 220 performs imaging, for example. At this time, the measurement unit 220 generates a captured image by imaging the surroundings. The captured image may be a visible light image or an infrared light image. That is, the imaging function may be implemented by an optical sensor capable of acquiring light of various wavelengths. The optical sensor enables to find an object, recognize the shape and color of the object, and the like, for example. The measurement unit 220 may store the captured image in the storage device 290, or may transmit the captured image to the control device 100 via the communication unit 210.

The measurement unit 220 measures, for example, position information. Specifically, the measurement unit 220 acquires the position information by receiving a positioning signal relating to the position information. For example, the measurement unit 220 may receive a signal transmitted from a positioning satellite of a global navigation satellite system (GNSS), such as a global positioning system (GPS) satellite, and acquire position information indicating the position of its host mobile body, based on the received signal. The measurement unit 220 may store the acquired position information in the storage device 290, or may transmit the acquired position information to the control device 100 via the communication unit 210.

The measurement unit 220 measures, for example, a distance. At this time, the measurement unit 220 measures a distance to a surrounding object. The distance measurement function may be implemented by a distance sensor. The distance sensor may be a sensor that measures a distance using laser light, such as light detection and ranging (LiDAR).

The measurement unit 220 may further have another function. For example, the measurement unit 220 may have a function of detecting an object implemented by a radar. For example, the measurement unit 220 may also have functions implemented by a temperature sensor, an atmospheric pressure sensor, a gyro sensor, an acceleration sensor, an ultrasonic sensor, a magnetic orientation sensor, and the like. The function of the measurement unit 220 may be different depending on the mobile body 200. For example, a magnetic orientation sensor is supposed to be mounted on the mobile body 200-1, but no magnetic orientation sensor is supposed to be mounted on the mobile body 200-2. Such information regarding the measurement function for each mobile body 200 is indicated in the function information.

The mobile body control unit 230 controls its host mobile body. Specifically, the mobile body control unit 230 controls its host mobile body in such a way as to fly on a navigation route to a destination. At this time, for example, the mobile body control unit 230 uses the position information acquired by the measurement unit 220 to control its host mobile body in such a way as not to deviate from the navigation route. The information indicating the navigation route is transmitted from the control device 100, for example. The information indicating the navigation route is not limited to this example and may be stored in advance in the storage device 290.

For example, the mobile body control unit 230 also performs control to follow another mobile body. At this time, the mobile body control unit 230 may perform control to follow another mobile body, based on, for example, a distance to the another mobile body measured by the measurement unit 220. The method for following is not limited to this example, and the mobile body control unit 230 may perform control to follow another mobile body by detecting the another mobile body by an imaging function or a function implemented by a radar or the like.

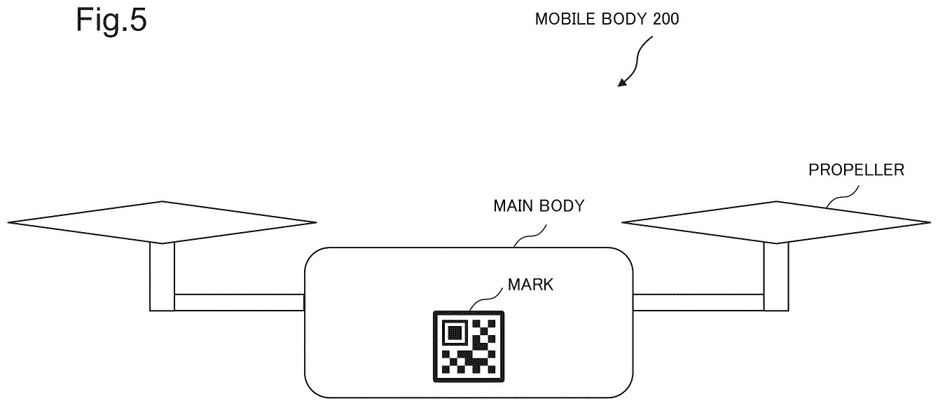

Here, an example of following by an imaging function will be described. FIG. 5 is a diagram illustrating an example of the mobile body 200. A mark is attached to the mobile body 200. In the example in FIG. 5, a two-dimensional barcode is illustrated as a mark. The mark is not limited to this example and may be a one-dimensional barcode, a symbol, a figure, character information, or the like. First, the mobile body control unit 230 finds a mark of another mobile body from the captured image acquired by the measurement unit 220. The mobile body control unit 230 detects the another mobile body and calculates a relative position of its host mobile body with respect to the another mobile body from the position and size of the found mark on the captured image. As a result, the mobile body control unit 230 follows the another mobile body.

The mobile body control unit 230 may also perform control relating to a measurement function. Specifically, the mobile body control unit 230 may perform control to turn on and off the measurement function. For example, the mobile body control unit 230 performs control to turn off the imaging function. In this case, the measurement unit 220 does not perform imaging.

The control device 100 includes an acquisition unit 110, a determination unit 120, and a control unit 130. The control device 100 also includes a storage device 190. The storage device 190 may be an external device capable of communicating with the control device 100.

The acquisition unit 110 acquires the function information. For example, the acquisition unit 110 acquires the function information from each of the mobile bodies 200. The acquisition unit 110 stores the acquired function information in the storage device 190. In a case where an information processing device (not illustrated) such as a personal computer is connected to the control device 100 in such a way that communication is allowed, the acquisition unit 110 may acquire the function information from the information processing device. In this case, the information processing device accepts an input of the function information from a user. In a case where the function information on each of the mobile bodies 200 is stored in advance in the storage device 190, the acquisition unit 110 may acquire the function information from the storage device 190.

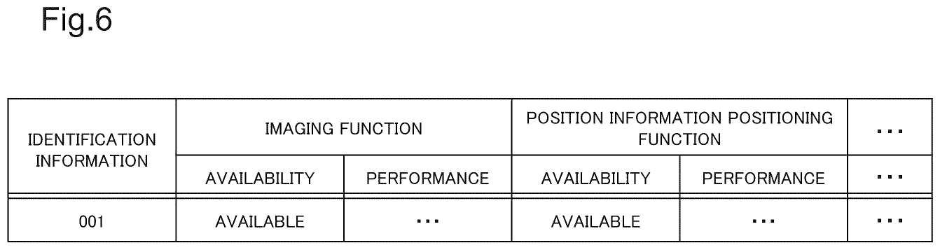

FIG. 6 depicts an example of the function information. In the example in FIG. 6, the function information regarding a mobile body with identification information “001” is illustrated. The identification information is information that identifies the mobile body. The function information includes information regarding a measurement function provided in the mobile body 200. In the example in FIG. 6, the function information indicates the availability of each measurement function and the performance of each measurement function. For example, the availability of the imaging function and the performance of the imaging function are illustrated. The acquisition unit 110 may acquire such function information on each of the mobile bodies 200.

The acquisition unit 110 may also acquire information measured by the mobile body 200 from the mobile body 200. The information measured by the mobile body will be referred to as measurement information. For example, the acquisition unit 110 may acquire the measurement information including measured position information and time from the mobile body 200. This allows the control device 100 to specify the current position of the mobile body, the path on which the mobile body 200 actually navigated, and the like. The acquisition unit 110 may store the measurement information acquired from the mobile body 200 in the storage device 190. At this time, the acquisition unit 110 may store the measurement information in association with the identification information on the mobile body.

The determination unit 120 determines the role of the mobile body 200 in accordance with a predetermined criterion. For example, information indicating the predetermined criterion is stored in the storage device 190. The determination unit 120 may determine a role, based on the information indicating the predetermined criterion, which is stored in the storage device 190. In a case where an information processing device capable of communicating with the control device 100 is involved, the acquisition unit 110 acquires the information indicating the predetermined criterion according to an input from the user. Then, the determination unit 120 may determine a role, based on the acquired information indicating the predetermined criterion.

An example of the predetermined criterion is whether the role has a required function. For example, the lead aircraft is assumed to be required to have an imaging function, a position information positioning function, and a distance measurement function. In this case, the determination unit 120 specifies a mobile body having the imaging function, the position information positioning function, and the distance measurement function, among the plurality of mobile bodies 200, based on the function information. The determination unit 120 determines the specified mobile body as a lead aircraft. Then, the determination unit 120 determines the other mobile bodies that have not been specified, as wingmen.

Another example of the predetermined criterion is superiority or inferiority of performance of a function provided in the mobile body 200. In this case, the determination unit 120 compares the function information. Then, the determination unit 120 may determine a mobile body having a function with superior performance, among the plurality of mobile bodies 200, as a lead aircraft. For example, the determination unit 120 may determine, as a lead aircraft, a mobile body capable of imaging with a highest number of pixels or a mobile body with a highest zoomable magnification, among the plurality of mobile bodies 200. For example, the determination unit 120 may determine a mobile body having a smallest error in the positioning function for the position information, among the plurality of mobile bodies 200, as a lead aircraft.

The approach for determining the roles is not limited to these examples. First, the determination unit 120 may specify at least one of the mobile bodies 200, based on whether the role has a required function. Then, in a case where a plurality of mobile bodies 200 is specified, the determination unit 120 may determine the role in accordance with superiority or inferiority of performance of the function. For example, the lead aircraft is assumed to be required to have a distance measurement function. Then, the determination unit 120 is assumed to have specified two mobile bodies having the distance measurement function, among the plurality of mobile bodies 200. In this case, the determination unit 120 may determine, as a lead aircraft, a mobile body having a superior distance measurement function (for example, a mobile body having a wider measurable distance range), among the two mobile bodies.

The control unit 130 performs control to cause the mobile bodies 200 to form a formation in accordance with the determined roles. Specifically, the control unit 130 transmits control information according to the lead aircraft to the mobile body 200 determined as a lead aircraft. The control unit 130 also transmits a control signal according to the wingman to the mobile body 200 determined as a wingman. Here, the mobile bodies 200-1, 200-2, and 200-3 are assumed to be involved. Then, the determination unit 120 is assumed to have determined that the mobile body 200-1 is a lead aircraft and the mobile bodies 200-2 and 200-3 are wingmen. In this case, the control unit 130 transmits, to the mobile body 200-1, control information including information indicating that the role is a lead aircraft and information indicating a navigation route. As a result, the mobile body control unit 230 of the mobile body 200-1 controls the mobile body 200-1 in such a way as to fly on the navigation route.

The control unit 130 transmits, to the mobile bodies 200-2 and 200-3, control information including information indicating that the role is a wingman and information indicating a following target mobile body. For example, the control unit 130 is assumed to have transmitted, to the mobile body 200-2, control information indicating the mobile body 200-1 as a following target. In this case, the mobile body control unit 230 of the mobile body 200-2 performs control to follow the mobile body 200-1. For example, the control unit 130 controls the mobile body 200-2 in such a way as to follow the mobile body 200-1 by causing the mobile body 200-2 to detect the mobile body 200-1 using a radar. The control unit 130 is not limited to this example and, for example, may control the mobile body 200-2 in such a way as to follow the mobile body 200-1 by causing the mobile body 200-2 to capture a mark attached to the mobile body 200-1.

Then, the control unit 130 is assumed to have transmitted, to the mobile body 200-3, control information indicating the mobile body 200-2 as a following target. In this case, the mobile body control unit 230 of the mobile body 200-3 performs control to follow the mobile body 200-2. Specific control relating to following is similar to the control for the mobile body 200-2.

The control information may include information indicating the position in the formation. In this case, the information indicating the following target mobile body includes information indicating the position in the formation. The position in the formation indicates a place where the mobile body is arranged in the pattern of formation when the formation flight is performed. For example, as the position in the formation, information on a direction and a distance with reference to the following target may be indicated. The mobile bodies 200-2 and 200-3 may perform formation flight, based on such information indicating the position in the formation.

The control information may include information indicating an instruction relating to the measurement function. That is, the control unit 130 may control the measurement function of the mobile body 200. For example, the control unit 130 transmits control information including an instruction to perform measurement for ensuring safety to the lead aircraft mobile body 200-1. In this case, the communication unit 210 of the mobile body 200-1 receives the control information. Then, the mobile body control unit 230 of the mobile body 200-1 causes the measurement unit 220 to perform various measurements in accordance with the control information. The control unit 130 may also transmit control information including an instruction to turn off a measurement function not necessary for following, to the wingmen mobile bodies 200-2 and 200-3. For example, in a case where the imaging function is not necessary for following, the control unit 130 transmits control information including an instruction to turn off the imaging function. The mobile body control units 230 of the mobile bodies 200-2 and 200-3 control the measurement units 220 in such a way as not to perform imaging in accordance with the control information. In this manner, the control unit 130 may perform control to cause the mobile body determined as a wingman to follow the lead aircraft or another wingman mobile body and to turn off a function not necessary for following.

In the above example, an example in which the control unit 130 controls each of the mobile bodies 200 has been described, but the control example for the mobile bodies 200 is not limited to this example. For example, the control unit 130 may only transmit control information including information indicating the determined role and information indicating the navigation route to each of the mobile bodies 200. In this case, the mobile body control unit 230 of each of the mobile bodies 200 may autonomously control its host mobile body in accordance with the information indicating the role. That is, each of the mobile bodies 200 may autonomously perform the formation flight by acquiring the control information from the control unit 130.

### Operation Example of Control Device 100

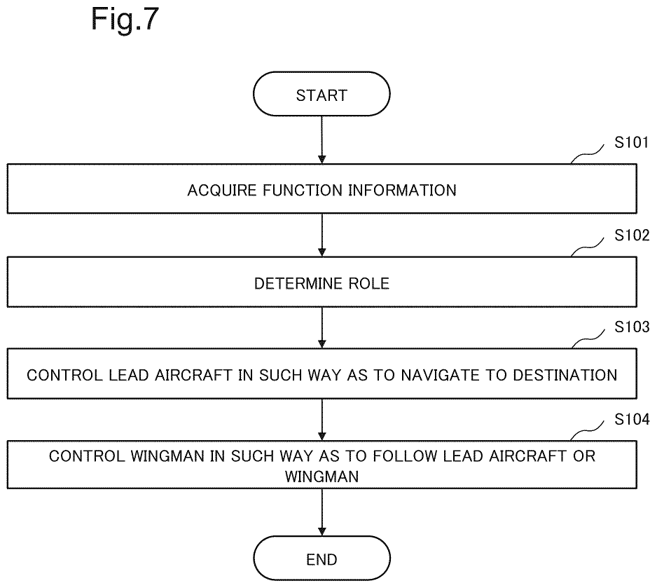

Next, an example of an operation of the control device 100 will be described with reference to FIG. 7. In this operation example, the mobile bodies 200-1, 200-2, and 200-3 are assumed to be involved. The lead aircraft is assumed to be required to have a predetermined measurement function. The wingman is assumed to follow the lead aircraft or another wingman with a radar.

FIG. 7 is a flowchart explaining an example of an operation of the control device 100. The acquisition unit 110 acquires the function information on the plurality of mobile bodies 200 (S101). For example, the acquisition unit 110 acquires the function information from each of the mobile bodies 200. The determination unit 120 determines the role of each of the mobile bodies 200 in accordance with a predetermined criterion (S102). For example, the determination unit 120 specifies a mobile body having a predetermined measurement function, among the mobile bodies 200-1, 200-2, and 200-3, based on the function information. Then, the mobile body 200 determines the specified mobile body as a lead aircraft. In this example, the determination unit 120 is assumed to have determined the mobile body 200-1 as a lead aircraft. Then, the determination unit 120 determines the mobile bodies 200-2 and 200-3 as wingmen.

The control unit 130 controls the lead aircraft mobile body in such a way as to navigate to a destination (S103). Specifically, the control unit 130 transmits, to the mobile body 200-1, control information including information indicating that the role is a lead aircraft, information indicating the navigation route, and an instruction to perform measurement for ensuring safety. The mobile body control unit 230 of the mobile body 200-1 controls the mobile body 200-1 to navigate in such a way as not to deviate from the navigation route to the destination, based on the control information.

The control unit 130 also controls the wingmen mobile bodies in such a way as to follow the lead aircraft or a wingmen (S104). Specifically, the control unit 130 transmits, to the mobile bodies 200-2 and 200-3, control information including information indicating that the role is a wingman, information indicating a following target mobile body, and an instruction to turn off a measurement function not necessary for following. The mobile body control units 230 of the mobile bodies 200-2 and 200-3 take control in such a way as to follow the target mobile body, based on the control information. At this time, the mobile body control units 230 turn off a measurement function not necessary for following. For example, a radar is assumed to be used for following and the imaging function is not assumed to be used for following. In this case, the mobile body control units 230 turn off the imaging function.

This operation example is merely an example. That is, the operation of the control device 100 is not limited to this example.

As described above, the control device 100 of the second example embodiment acquires the function information indicating measurement functions provided in each of the plurality of mobile bodies 200. The control device 100 determines, among the plurality of mobile bodies 200, the role of one mobile body having a measurement function meeting a predetermined criterion, as a lead aircraft, and the roles of the other mobile bodies as wingmen, based on the function information. Then, the control device 100 performs control to cause the plurality of mobile bodies to form a formation in accordance with the determined roles.

When the mobile bodies form a formation, roles such as the lead aircraft and the wingman may sometimes be set. At this time, a required measurement function may sometimes be defined in accordance with the task of the lead aircraft or the wingman. For example, in such a case, the control device 100 can appropriately assign the role, based on the function information indicating the measurement function. That is, the control device 100 can assist in control of a plurality of mobile bodies.

Delivery of supplies may sometimes be performed as a service using a plurality of mobile bodies. In this case, supplies are loaded on the mobile bodies, and the mobile bodies navigate to the delivery destination. Here, the mobile body has a payload. The payload indicates the weight of an object that can be loaded on the mobile body. The larger the payload, the more efficiently the supplies can be delivered. The payload may sometimes be related also to the weight of the mobile body itself. For example, two mobile bodies having the same buoyancy and different weights of the mobile bodies are assumed. In this case, the payload of a mobile body having a larger weight tends to be smaller than the payload of a mobile body having a smaller weight. A variety of functions including a measurement function may sometimes be mounted on the mobile body. As the number of functions to be mounted increases, sensors and devices necessary for the functions are mounted on the mobile body, and thus, the weight of the mobile body itself becomes larger. Therefore, for the purpose of ensuring the payload, a mobile body having a minimum necessary function may sometimes be used for delivery of supplies. For example, in a case where a plurality of mobile bodies is caused to form a formation and used to deliver supplies, various functions such as a measurement function for ensuring safety is mounted on at least one mobile body. Then, a function for following the one mobile body is mounted on the other mobile bodies at a minimum. In such a situation, the control device 100 of the present disclosure can appropriately determine a mobile body having a measurement function for ensuring safety, among the plurality of mobile bodies 200, as a lead aircraft. The control device 100 can also appropriately determine other mobile bodies among the plurality of mobile bodies 200, as wingmen.

The control device 100 may also perform control to cause the mobile body determined as a wingmen to follow the lead aircraft or another wingman mobile body and to turn off a function not necessary for following. This allows the control device 100 to suppress consumption of a battery of the wingman due to a function not necessary for following.

A mark may be attached to each of the plurality of mobile bodies 200. Then, the control device 100 may cause the wingman mobile body to follow another mobile body by causing the wingman mobile body to image the mark. This allows the control device 100 to cause even a mobile body on which a sensor such as a radar is not mounted, to follow another mobile body.

### First Modification

The patterns of formation in a case where the mobile bodies 200 perform the formation flight may have variations. For example, the mobile bodies 200 may be placed in a line along a traveling direction, or may be placed in a line in such a way as to cross a traveling direction. The mobile bodies 200 may also be placed to form a plurality of lines.

The control unit 130 may specify an optimal formation in accordance with a condition and control the mobile bodies 200 in such a way as to form the specified formation. In this case, the control unit 130 uses a learning model in which the relationships between various conditions and the patterns of formation have been learned. An example of the learning model is a model in which a relationship between weather information, a battery consumption of a mobile body, and a pattern of formation has been learned. The learning model is trained by reinforcement learning, deep learning using a neural network, or the like, but is not limited to these examples. The learning model may be stored in the storage device 190.

At this time, the acquisition unit 110 acquires the weather information on the navigation route of the mobile body 200. The weather information is information regarding weather indicating meteorological conditions, precipitation, volume of wind flow, temperature, atmospheric pressure, and the like. The acquisition unit 110 acquires the weather information from, for example, an external server having data regarding a weather forecast.

The control unit 130 uses the weather information to specify a pattern of formation with a smaller battery consumption, based on the learning model. Then, the control unit 130 controls the mobile bodies 200 in such a way as to navigate in the specified pattern of formation.

This allows the control device 100 to suppress battery consumption.

### Third Example Embodiment

Next, a control device according to a third example embodiment will be described. In the third example embodiment, an example in which a mobile body is controlled in accordance with a notification from the mobile body will be described. The description of content that is duplicate of that of the first and second example embodiments will be partially omitted.

In the third example embodiment, a situation in which a plurality of mobile bodies is flying in formation is supposed. That is, in the situation, the roles have already been determined for each of the plurality of mobile bodies. In the present example embodiment, a control example when a notification is transmitted from the lead aircraft mobile body will be mainly described.

### Details of Mobile Body Control System 1001

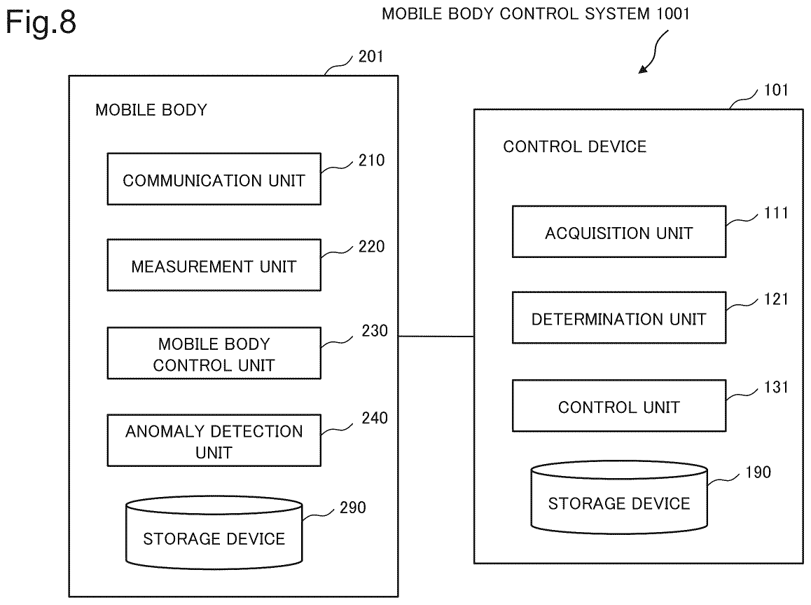

FIG. 8 is a block diagram illustrating an example of a configuration of a mobile body control system 1001. The mobile body control system 1001 includes a control device 101 and a mobile body 201. Similarly to the mobile body 200, a plurality of mobile bodies 201 is involved. That is, mobile bodies 201-1, 201-2, . . . , 201-n (n is a natural number equal to or more than two) are involved. In a case where the mobile bodies 201-1, 201-2, . . . , and 201-n are not distinguished from each other, they will be simply referred to as mobile bodies 201. The mobile body 201 may perform an operation to be described below in addition to the operation of the mobile body 200. Similarly, the control device 101 may perform an operation to be described below in addition to the operation of the control device 100.

The mobile body 201 includes a communication unit 210, a measurement unit 220, a mobile body control unit 230, an anomaly detection unit 240, and a storage device 290. The anomaly detection unit 240 detects an anomaly that has occurred in the mobile body 201. Specifically, the anomaly detection unit 240 may detect an anomaly relating to the measurement function. For example, the measurement unit 220 is assumed to have a position information positioning function. At this time, the measurement unit 220 is assumed to no longer measure the position information. At this time, the anomaly detection unit 240 detects that an anomaly has occurred in the position information positioning function. Similarly, the measurement unit 220 is assumed to have an imaging function. When the measurement unit 220 can no longer perform imaging, the anomaly detection unit 240 detects that an anomaly has occurred in the imaging function. In this manner, the anomaly detection unit 240 detects an anomaly that has occurred in the measurement function. The anomaly detection unit 240 is an example of an anomaly detection means.

The example of anomaly detection is not limited to these examples. The anomaly detection unit 240 may detect an anomaly relating to the battery. For example, in a case where the remaining capacity of the battery of the mobile body 201 has become less than a predetermined threshold, the anomaly detection unit 240 detects that an anomaly has occurred in the battery. For example, the anomaly detection unit 240 detects that an anomaly has occurred in the propeller in a case where the rotation of the propeller has blocked or a case where the rotation has become slower.

When detecting that an anomaly has occurred, the anomaly detection unit 240 transmits a notification indicating the occurrence of the anomaly to the control device 101 via the communication unit 210. The notification indicating the occurrence of an anomaly includes information indicating the type of the anomaly, the identification information on the mobile body in which the anomaly has occurred, and the role of the mobile body. For example, when detecting that an anomaly has occurred in the position information positioning function, the anomaly detection unit 240 transmits a notification including the identification information on its host mobile body, information indicating whether its host mobile body is a lead aircraft or a wingman, and information indicating that an anomaly has occurred in the position information positioning function. Hereinafter, a notification indicating that an anomaly has occurred will be referred to as an anomaly notification.

The control device 101 includes an acquisition unit 111, a determination unit 121, and a control unit 131. The acquisition unit 111 acquires the anomaly notification from the mobile body 201. Furthermore, the acquisition unit 111 acquires the function information on the plurality of mobile bodies 201. For example, the acquisition unit 111 acquires the function information from each of the mobile bodies 201. In a case where the function information on the mobile bodies 201 is stored in advance in a storage device 190, the acquisition unit 111 may acquire the function information from the storage device 190.

The determination unit 121 determines the role of the mobile body 201. First, the determination unit 121 verifies whether the mobile body in which an anomaly has occurred is a lead aircraft or a wingman, based on the anomaly notification. In a case where the mobile body in which an anomaly has occurred is a lead aircraft, the determination unit 121 newly determines roles for the plurality of mobile bodies 201. Specifically, in a case where the mobile body in which an anomaly has occurred is a lead aircraft, the determination unit 121 newly determines the role of the lead aircraft mobile bode as a wingman. Then, based on the function information, the determination unit 120 determines the lead aircraft mobile body from other mobile bodies that do not correspond to the mobile body newly determined as a wingman. That is, based on the function information, the determination unit 121 determines, among the wingmen mobile bodies flying in formation, the role of one mobile body having a measurement function that meets a predetermined criterion, as a lead aircraft. The approach for determining the lead aircraft mobile body may be similar to those in the first and second example embodiments.

The control unit 131 controls the mobile bodies 201 in accordance with the newly determined roles. At this time, the control unit 131 reassembles the formation in accordance with the newly determined roles. Specifically, the control unit 131 controls the mobile body newly determined as a lead aircraft in such a way as to fly on the navigation route while performing measurement for ensuring safety. The control unit 131 also performs control to cause the mobile body newly determined as a wingman (that is, the mobile body in which an anomaly has occurred) to follow the mobile body newly determined as a lead aircraft or another wingman mobile body. Then, the control unit 131 may control the mobile body newly determined as a wingman to turn off a function not necessary for following.

At this time, the control unit 131 may perform control in accordance with the content of the anomaly notification. For example, the anomaly notification is assumed to indicate an anomaly in a measurement function relating to the position information. In this case, the mobile body in which the anomaly has occurred may be unlikely to be able to follow using the position information positioning function. Thus, the control unit 131 controls the anomaly mobile body in such a way as to follow another mobile body by a following method not using the position information positioning function. For example, the control unit 131 performs control to cause the anomaly mobile body to follow the lead aircraft or another wingman mobile body, using the imaging function.

For example, the anomaly notification is assumed to indicate an anomaly relating to the remaining capacity of the battery. In this case, the remaining capacity of the battery of the mobile body in which the anomaly has occurred may be likely to run out during the flight. Thus, in such a case, the control unit 131 may control the anomaly mobile body to turn off a function not necessary for following another mobile body.

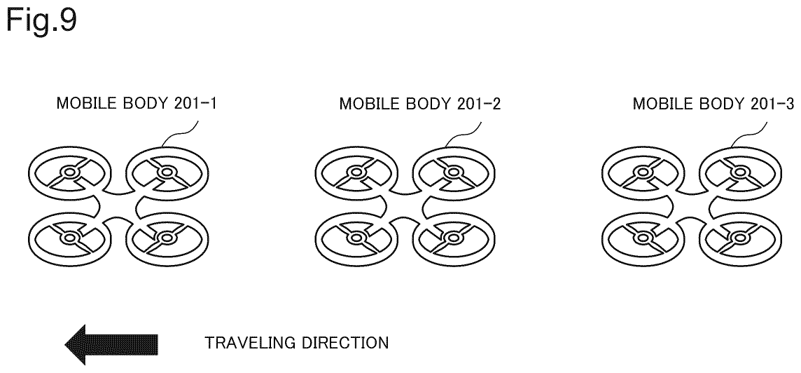

Here, an example of a process of newly determining roles when an anomaly has occurred in the lead aircraft will be described. FIG. 9 is a diagram schematically illustrating an example of the mobile bodies 201 forming a formation. In the example in FIG. 9, the mobile bodies 201-1, 201-2, and 201-3 are placed in a line and are navigating in the traveling direction indicated by the arrow. The mobile body 201-1 is a lead aircraft, and the mobile bodies 201-2 and 201-3 are wingmen.

In this case, an anomaly occurs in the mobile body 201-1. The determination unit 121 determines the mobile body 201-1 in which the anomaly has occurred, as a wingman. The determination unit 121 also determines the lead aircraft from the mobile bodies 201-2 and 201-3. At this time, the determination unit 121 determines a mobile body that meets a predetermined criterion, as a lead aircraft, based on the function information. In this example, the mobile body 201-3 is assumed to be newly determined as a lead aircraft. The control unit 131 controls the mobile bodies 201 in accordance with the newly determined roles. For example, the control unit 131 causes each of the mobile bodies 201 to hover and stop in the air. The control unit 131 switches the positions of the mobile bodies 201-1 and 201-3. Then, the control unit 131 controls the mobile body 201-1 in such a way as to follow the mobile body 201-2. At this time, the control unit 131 may employ another following method in accordance with the content of the anomaly notification to perform control for following.

The control unit 131 also controls the mobile body 201-3 in such a way as to fly on the navigation route while performing measurement for ensuring safety. In a case where a function not necessary for following is turned off in the mobile body 201-3, the mobile body control unit 230 of the mobile body 201-3 turns on a measurement function for ensuring safety.

In this manner, when the mobile bodies are flying in formation, the control unit 131 switches the positions of the mobile body newly determined as a lead aircraft and the mobile body newly determined as a wingman in the formation.

The method for newly determining a lead aircraft is not limited to the above example. For example, the mobile bodies 201-2 and 201-3 are assumed to be mobile bodies having the same function. That is, the mobile bodies 201-2 and 201-3 are assumed to have no difference in function. In this case, the determination unit 121 may newly determine a mobile body closest to the original lead aircraft, as a lead aircraft. In the example in FIG. 9, the mobile body 201-2 is closer to the mobile body 201-1 than the mobile body 201-3. Therefore, the determination unit 121 newly determines the mobile body 201-2 as a lead aircraft. This allows the formation to be reassembled without greatly moving the mobile body newly determined as a lead aircraft and the mobile body newly determined as a wingman.

When the formation is reassembled, the mobile body newly determined as a lead aircraft and the mobile body newly determined as a wingman do not need to be switched. For example, in the example in FIG. 9, the mobile body 201-3 is assumed to be newly determined as a lead aircraft. At this time, the control unit 131 may reassemble the formation by moving the mobile body 201-3 to the front of the mobile body 201-1. In this case, the control unit 131 causes the mobile body 201-1 to follow the mobile body 201-3 and causes the mobile body 201-2 to follow the mobile body 201-1.

### Operation Example of Control Device 101

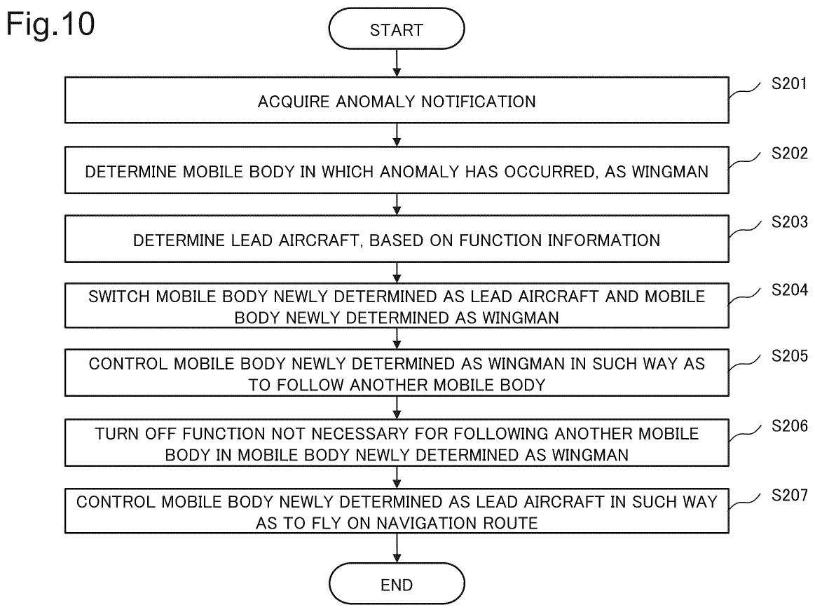

Next, an example of an operation of the control device 101 will be described with reference to FIG. 10. In this operation example, the mobile bodies 201-1, 201-2, and 201-3 are assumed to be involved as illustrated in FIG. 9. The mobile body 201-1 is assumed to be a lead aircraft, and an anomaly in the position information measurement function is assumed to be detected in the mobile body 201-1.

FIG. 10 is a flowchart explaining an example of an operation of the control device 101.

When detecting an anomaly, the anomaly detection unit 240 of the mobile body 201-1 transmits the anomaly notification to the control device 101. The acquisition unit 111 of the control device 101 acquires the anomaly notification from the mobile body 201-1 (S201). The determination unit 121 determines the mobile body 201-1 in which the anomaly has occurred, as a wingman (S202). The determination unit 121 also determines the lead aircraft from the mobile bodies 201-2 and 201-3, based on the function information (S203). For example, the mobile body 201-3 is determined as a lead aircraft.

The control unit 131 controls the mobile bodies 201 in accordance with the roles. Specifically, the control unit 131 switches the mobile body newly determined as a lead aircraft and the mobile body newly determined as a wingman (S204). For example, the control unit 131 switches the position of the mobile body 201-1 and the position of the mobile body 201-3 in the formation.

The control unit 131 controls the mobile body newly determined as a wingman in such a way as to follow another mobile body (S205). At this time, in the mobile body 201-1, an anomaly has occurred in the position information positioning function. Thus, the control unit 131 causes the mobile body 201-1 to follow by a following method not using the position information positioning function. For example, the control unit 131 causes the mobile body 201-1 to detect a mark attached to the mobile body 201-2, using the imaging function, and controls the mobile body 201-1 in such a way as to follow the mobile body 201-2.

The control unit 131 also performs control to turn off a function not necessary for following another mobile body in the mobile body newly determined as a wingman (S206). Then, the control unit 131 controls the mobile body newly determined as a lead aircraft in such a way as to fly on the navigation route (S207).

This operation example is merely an example. That is, the operation of the control device 101 is not limited to this example.

As described above, the control device 101 of the third example embodiment may acquire a notification indicating the occurrence of an anomaly from the lead aircraft mobile body flying in formation. Then, the control device 101 newly determines the role of the lead aircraft mobile body as a wingman and determines the role of one mobile body having a measurement function meeting a predetermined criterion, among wingmen mobile bodies flying in formation, as a lead aircraft, based on the function information.

This allows the control device 101 to navigate the mobile bodies 200 without canceling the formation flight even in a case where an anomaly has occurred in the lead aircraft.

Here, in a case where an anomaly in the measurement function relating to the position information is indicated in the notification, the control device 101 may perform control to cause the mobile body newly determined as a wingman to follow the lead aircraft or another wingman mobile body, using the imaging function. This allows the control device 101 to cause the mobile body in which the anomaly has occurred to follow according to the function usable by the anomaly mobile body.

In a case where an anomaly relating to the remaining capacity of the battery is indicated, the control device 101 may control the mobile body newly determined as a wingman to turn off a function not necessary for following another mobile body. As a result, the mobile body newly determined as a wingman can be navigated while a decrease in the remaining capacity of the battery is suppressed.

### Second Modification

In the third example embodiment, an example of a case where an anomaly has occurred in the lead aircraft mobile body has been mainly described. Even in a case where an anomaly has occurred in a wingman mobile body, the control device 101 may control the mobile bodies in accordance with the content of the anomaly.

For example, in the example in FIG. 9, an anomaly is assumed to have occurred in the mobile body 201-2. At this time, the anomaly detection unit 240 of the mobile body 201-2 detects the anomaly. Then, the anomaly detection unit 240 transmits the anomaly notification to the control device 101.

The acquisition unit 111 acquires the anomaly notification. The determination unit 121 verifies whether the mobile body in which the anomaly has occurred is a lead aircraft or a wingman, based on the anomaly notification. Since the mobile body 201-2 is a wingman, the determination unit 121 verifies that the mobile body in which the anomaly has occurred is a wingman. Then, the determination unit 121 determines whether to withdraw the mobile body in which the anomaly has occurred, in accordance with the content of the anomaly notification. For example, the anomaly notification is assumed to indicate an anomaly relating to the remaining capacity of the battery. At this time, the determination unit 121 verifies whether the anomaly mobile body can navigate to the destination, according to the remaining capacity of the battery and the remaining navigation route. Then, in a case where the navigation is determined to be possible, the determination unit 121 determines not to withdraw the mobile body in which the anomaly has occurred. In a case where the navigation is determined not to be possible, the determination unit 121 determines to withdraw the mobile body in which the anomaly has occurred.

In a case where withdrawal of the mobile body in which the anomaly has occurred is determined, the control unit 131 withdraws the mobile body in which the anomaly has occurred. Specifically, the control unit 131 causes the mobile body 201-2 to leave the formation and withdraw to a withdrawal destination. An example of the withdrawal destination is a place for withdrawal installed in advance near the navigation route. A plurality of places for withdrawal may be installed. An example of the place for withdrawal is a charging spot. The charging spot is a facility that allows the mobile body to charge the battery. In a case where the mobile body can freely navigate, charging spots may sometimes be installed in several places. Such a charging spot may be utilized as a place for withdrawal.

When withdrawing the mobile body 201-2, the control unit 131 controls the mobile body 201-3 in such a way as to follow the mobile body 201-1.

In this manner, the control device 101 may withdraw the mobile body in which an anomaly has occurred.

The mobile body 201 may not be able to navigate as intended in some cases depending on the type of anomaly. For example, in a case where an anomaly has occurred in the position information positioning function, the control device 101 may be unlikely to be allowed to appropriately withdraw the mobile body 201. In such a case, the control device 101 performs control to cause the mobile body 201 to image the surroundings.

For example, code information such as a two-dimensional barcode is installed in advance in a building or the like near the navigation route. The code information is installed at a plurality of locations. The code information indicates position information on an installation place. Then, the control unit 131 of the control device 101 causes the mobile body 201 to read the code information by causing the mobile body 201 to image the surroundings. The measurement unit 220 of the mobile body 201 reads the code information. Then, the measurement unit 220 acquires the position information indicated by the code information. The mobile body control unit 230 of the mobile body 201 can correct the position information on the mobile body 201, using the acquired position information. This allows the control device 101 to appropriately withdraw the mobile body in which an anomaly has occurred in the position information positioning function.

### Fourth Example Embodiment

Next, a control device according to a fourth example embodiment will be described. In the fourth example embodiment, an example in which the mobile body is caused to join or leave the formation in a planned manner will be described. The description of content that is duplicate of that of the first, second, and third example embodiments will be partially omitted.

In the fourth example embodiment, a situation in which mobile bodies are flying in formation is supposed. Here, one or more formations may be involved. Furthermore, navigation routes to the destination are set for each mobile body. That is, a mobile body that navigates alone is also involved.

### Details of Mobile Body Control System 1002

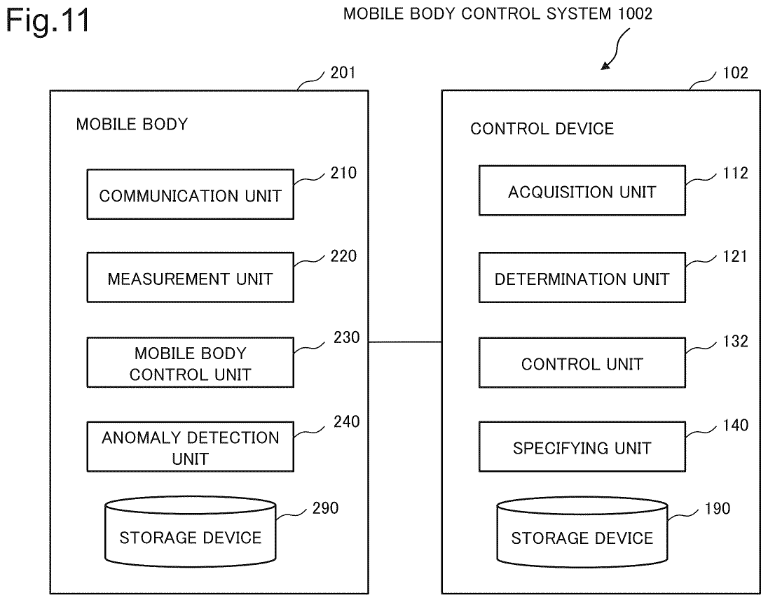

FIG. 11 is a block diagram illustrating an example of a configuration of a mobile body control system 1002. The mobile body control system 1001 includes a control device 102 and a mobile body 201. The control device 102 controls the mobile body 201. The control device 102 may perform an operation described below in addition to the operation of the control device 101.

The control device 102 includes an acquisition unit 112, a determination unit 121, a control unit 132, and a specifying unit 140. The acquisition unit 112 acquires formation navigation information and mobile body navigation information. The formation navigation information is information in which a navigation route of a formation to be navigated and a navigation time are associated with each other. The formation navigation information is defined for each formation. The mobile body navigation information is information in which a navigation route of the mobile body and a navigation time are associated with each other. The mobile body navigation information is defined for each individual mobile body.

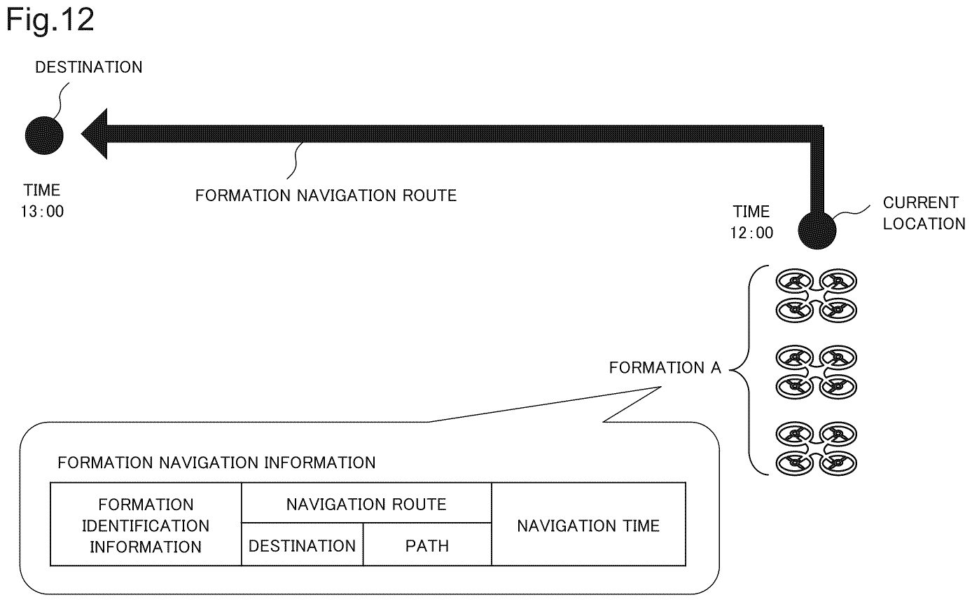

FIG. 12 is a diagram schematically illustrating an example of the formation navigation information. In the example in FIG. 12, the formation navigation information is indicated as information in which formation identification information that identifies a formation, a navigation route of the formation, and a navigation time are associated with each other. Here, the navigation route of the formation will be referred to as a formation navigation route in order to be distinguished from the navigation route of the individual mobile body. In FIG. 12, the formation navigation route of a formation A, the time at the current location, and the scheduled time when the formation A will arrive at the destination are illustrated. The formation navigation route includes information indicating the destination and a path scheduled to be navigated. Furthermore, the formation navigation information may indicate a departure time at the departure point and a time at which a waiting point to be described later is passed. The formation navigation information is not limited to this example and may indicate only the formation navigation route and the departure time. In this manner, the formation navigation information may define the formation navigation route and the arrival time of the formation at a predetermined point on the formation navigation route for each formation.

The formation navigation information may be information set in advance. In this case, the formation navigation information is stored in advance in a storage device 190. For example, an information processing device (not illustrated) connected to the control device 102 in such a way that communication is allowed accepts an input of the formation navigation information from the user. Then, the acquisition unit 112 of the control device 102 acquires the formation navigation information from the information processing device. The acquisition unit 112 stores the acquired formation navigation information in the storage device 190. That is, when one formation is formed, the control unit 132 may control a plurality of mobile bodies 201, based on the formation navigation information.

The formation navigation information may be updated in accordance with information acquired from the mobile body 201. The acquisition unit 112 acquires the measurement information from the mobile body 201. Specifically, the acquisition unit 112 acquires the measurement information from the lead aircraft of the formation. Then, the acquisition unit 112 may add the position information and the time information indicated in the measurement information to the formation navigation information. This allows the control device 102 to specify the current position of the formation and the path through which the formation has actually passed.

The formation navigation information is not limited to this example. For example, the formation navigation information may include information indicating the pattern of formation.

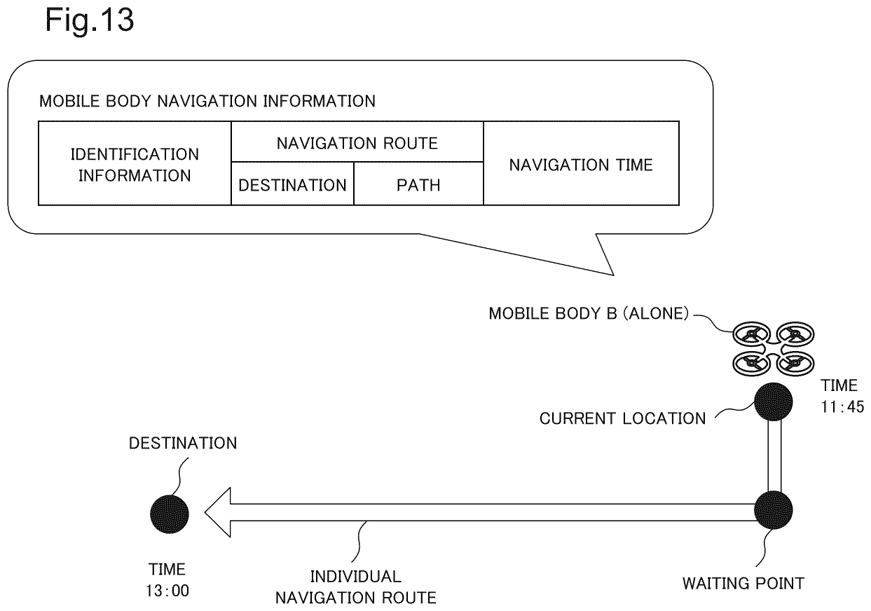

FIG. 13 is a diagram schematically illustrating an example of the mobile body navigation information. In the example in FIG. 13, the mobile body navigation information is indicated as information in which identification information that identifies a mobile body, a navigation route of the mobile body, and a navigation time are associated with each other. Here, the navigation route of the mobile body will be referred to as an individual navigation route in order to be distinguished from the formation navigation route. In FIG. 13, the individual navigation route of a mobile body B, the time of the current location, and the scheduled time when the mobile body B will arrive at the destination are illustrated. The individual navigation route includes information indicating the destination and a path scheduled to be navigated. The individual navigation information is not limited to this example and may indicate a departure time at the departure point and a time at which a waiting point to be described later is passed. In this manner, the mobile body navigation information may define the individual navigation route and the arrival time of the formation at a predetermined point on the individual navigation route for each mobile body.

The mobile body navigation information may be information set in advance. In this case, the mobile body navigation information is stored in advance in the storage device 190. For example, an information processing device (not illustrated) connected to the control device 102 in such a way that communication is allowed accepts an input of the mobile body navigation information from the user. Then, the acquisition unit 112 of the control device 102 acquires the mobile body navigation information from the information processing device. The acquisition unit 112 stores the acquired mobile body navigation information in the storage device 190.

The mobile body navigation information may be information acquired from the mobile body 201. In this case, the mobile body navigation information is stored in a storage device 290 of the mobile body 201. For example, the acquisition unit 112 sends a request for the mobile body navigation information to the mobile body 201. When receiving the request, the communication unit 210 of the mobile body 201 transmits the mobile body navigation information to the control device 102. Then, the acquisition unit 112 acquires the mobile body navigation information.

The mobile body navigation information may be updated in accordance with information acquired from the mobile body 201. The acquisition unit 112 acquires the measurement information from the mobile body 201. Then, the acquisition unit 112 may add the position information and the time information indicated in the measurement information to the mobile body navigation information. This allows the control device 102 to specify the current position of the mobile body 201 and the path through which the mobile body 201 has actually passed.

The specifying unit 140 specifies a predetermined formation or a predetermined mobile body depending on the situation. The specifying unit 140 is an example of a specifying means. A specific process of the specifying unit 140 and the control unit 132 will be described in the following specific examples.

### Specific Example 1

In Specific Example 1, a situation in which a predetermined mobile body joins a formation will be described. That is, the control device 102 performs control to cause a predetermined mobile body to join a formation. Here, the predetermined mobile body is a single mobile body.

The specifying unit 140 estimates a time at which the mobile body will arrive at a waiting point, based on the mobile body navigation information on the predetermined mobile body. The waiting point indicates a point on the navigation route. An example of the waiting point is a point in a corridor. The corridor is a specified region set in the air for passage of the mobile bodies. The corridor serves as a road for the mobile bodies. The corridor may be a dedicated airspace for passage of the mobile bodies, in which a service for allowing the mobile bodies to pass safely is provided. An airspace that is such a dedicated airspace and particularly specialized for a drone may sometimes be called a drone highway. The mobile bodies forming a formation are considered to pass through such a corridor. For example, the predetermined mobile body joins a formation flying in the corridor at the waiting point.

For example, the specifying unit 140 estimates the time at which the predetermined mobile body will arrive at the waiting point, based on the position information on the predetermined mobile body and the position of the waiting point on the individual navigation route. The specifying unit 140 also specifies a formation that will pass through the waiting point within predetermined time from the estimated time, among formations directed in the same direction as the traveling direction of the predetermined mobile body, based on the formation navigation information.

In a case where a formation is specified by the specifying unit 140, the control unit 132 performs control to cause the predetermined mobile body to follow a mobile body of the specified formation at the waiting point.

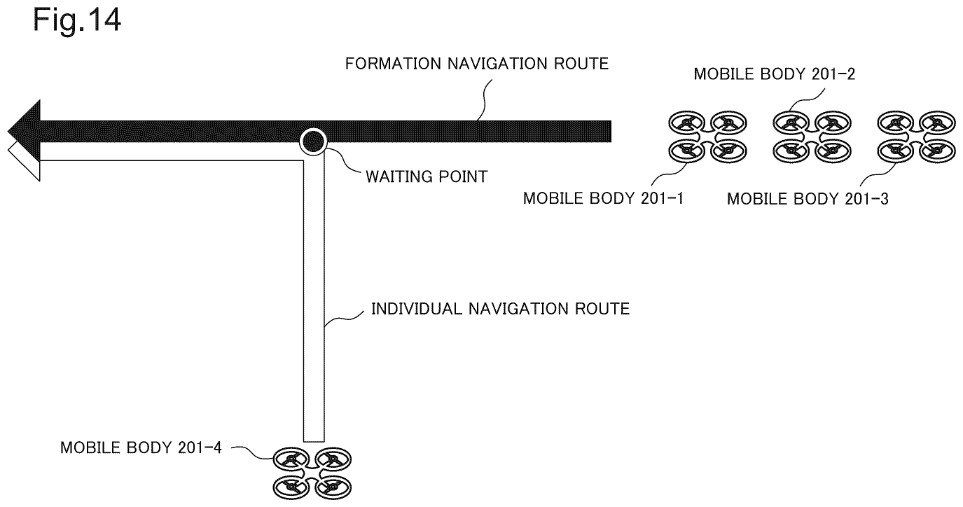

FIG. 14 is a diagram explaining an example of a situation in which a mobile body joins a formation. In the example in FIG. 14, the mobile bodies 201-1, 201-2, and 201-3 are flying in formation. A mobile body 201-4 is flying alone. That is, in this example, the mobile body 201-4 corresponds to the above-described predetermined mobile body. For example, the specifying unit 140 estimates the time at which the mobile body 201-4 will arrive at the waiting point, based on the mobile body information on the mobile body 201-4. The specifying unit 140 also verifies whether the formation made up of the mobile bodies 201-1, 201-2, and 201-3 will pass through the waiting point within predetermined time from the estimated time, based on the formation navigation information. Then, in a case where the formation is verified to pass through the waiting point within the predetermined time, the specifying unit 140 specifies the formation. That is, the specifying unit 140 specifies a formation that will pass through the waiting point within predetermined time when the mobile body 201-4 arrives at the waiting point.

The control unit 132 causes the mobile body 201-4 to stay at the waiting point. For example, the control unit 132 causes the mobile body 201-4 to hover and stop in the air. Then, when the specified formation arrives at the waiting point, the control unit 132 performs control to cause the mobile body 201-4 to follow the mobile body 201-3, for example. As a result, the mobile body 201-4 joins the formation at the waiting point. The waiting point corresponds to the role of a station.

In a case where no formation is specified by the specifying unit 140, the control unit 132 controls the mobile body 201-4 in such a way as to navigate according to the individual navigation route.

As described above, the specifying unit 140 specifies a formation that will pass through the waiting point within predetermined time when the predetermined mobile body arrives at the waiting point, based on the formation navigation information. Then, in a case where a formation is specified, the control unit 132 performs control to cause the predetermined mobile body to follow a mobile body of the specified formation at the waiting point.

### Specific Example 2

In Specific Example 2, a situation in which at least one of mobile bodies flying in a predetermined formation leaves the formation will be described. That is, the control device 102 performs control to cause the mobile body to leave the predetermined formation.

The specifying unit 140 specifies a mobile body that is to leave the predetermined formation. Specifically, the specifying unit 140 specifies a mobile body that is to deviate from the formation navigation route, based on the formation navigation information on the predetermined formation and the mobile body navigation information on the mobile bodies in the predetermined formation. For example, when the path indicated by the formation navigation information is different from the path indicated by the mobile body navigation information, the mobile body relevant to that mobile body navigation information will deviate from the formation navigation route. The specifying unit 140 further specifies a leaving point that is a point where the specified mobile body leaves the formation.

In a case where a mobile body is specified by the specifying unit 140, the control unit 132 causes the specified mobile body to leave the predetermined formation. Here, in a case where the mobile body that has been caused to leave has a follower mobile body, the control unit 132 performs control to cause a mobile body that has followed the mobile body that has been caused to leave to follow another mobile body in the predetermined formation.

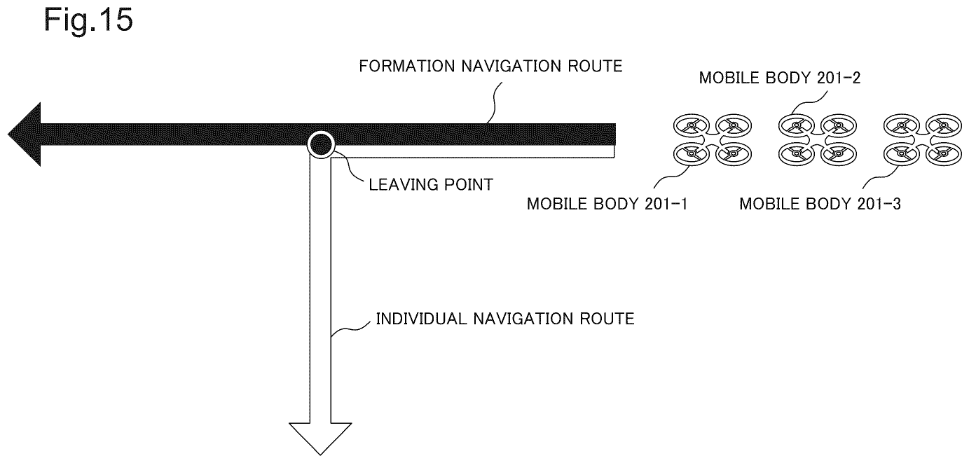

FIG. 15 is a diagram explaining an example of a situation in which a mobile body leaves a formation. In the example in FIG. 15, the mobile bodies 201-1, 201-2, and 201-3 are flying in formation. Among them, the mobile body 201-2 is assumed to be a mobile body that is to leave the formation. For example, the specifying unit 140 specifies that the mobile body 201-2 is a mobile body that is to deviate from the formation navigation route, based on the formation navigation information on the formation and the mobile body navigation information on the mobile body 201-2. At this time, the specifying unit 140 also specifies the leaving point of the mobile body 201-2. Then, when the formation arrives at the leaving point, the control unit 132 controls the mobile body 201-2 in such a way as to navigate the individual navigation route. The control unit 132 also controls the mobile body 201-3 in such a way as to follow the mobile body 201-1.

As described above, the specifying unit 140 specifies a mobile body that is to deviate from the formation navigation route, among the mobile bodies navigating in a predetermined formation, based on the formation navigation information and the mobile body navigation information. The control unit 132 causes the specified mobile body to leave the predetermined formation. Then, the control unit 132 performs control to cause a mobile body that has followed the specified mobile body to follow another mobile body in the predetermined formation different from the specified mobile body.

### Operation Example 1 of Control Device 102

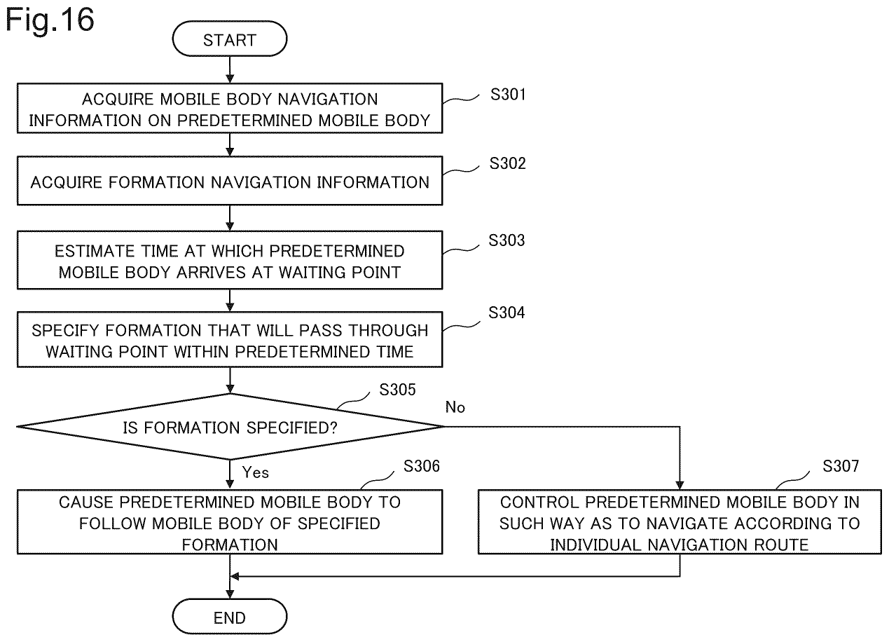

Next, a first example of an operation of the control device 102 will be described with reference to FIG. 16. In this operation example, an example of a case where a predetermined mobile body joins a formation will be described. The predetermined mobile body is a mobile body that does not form a formation.

FIG. 16 is a flowchart explaining the first example of an operation of the control device 102. The acquisition unit 112 acquires the mobile body navigation information on the predetermined mobile body (S301). The acquisition unit 112 also acquires the formation navigation information (S302). The specifying unit 140 estimates a time at which the predetermined mobile body will arrive at the waiting point, based on the mobile body navigation information (S303). Then, the specifying unit 140 specifies a formation that will pass through the waiting point within predetermined time from the estimated time (S304). Specifically, the specifying unit 140 specifies a formation that will pass through the waiting point within predetermined time from the estimated time, among formations directed in the same direction as the traveling direction of the predetermined mobile body, based on the formation navigation information.

In a case where a formation is specified (“Yes” in S305), the control unit 132 causes the predetermined mobile body to follow a mobile body of the specified formation (S306). At this time, in a case where the specified formation has time until arriving at the waiting point, the control unit 132 may cause the predetermined mobile body to stand by until the formation arrives at the waiting point.

In a case where no formation is specified (“No” in S305), the control unit 132 controls the predetermined mobile body in such a way as to navigate according to the individual navigation route (S307).

This operation example is merely an example. That is, the operation of the control device 102 is not limited to this example.

### Operation Example 2 of Control Device 102

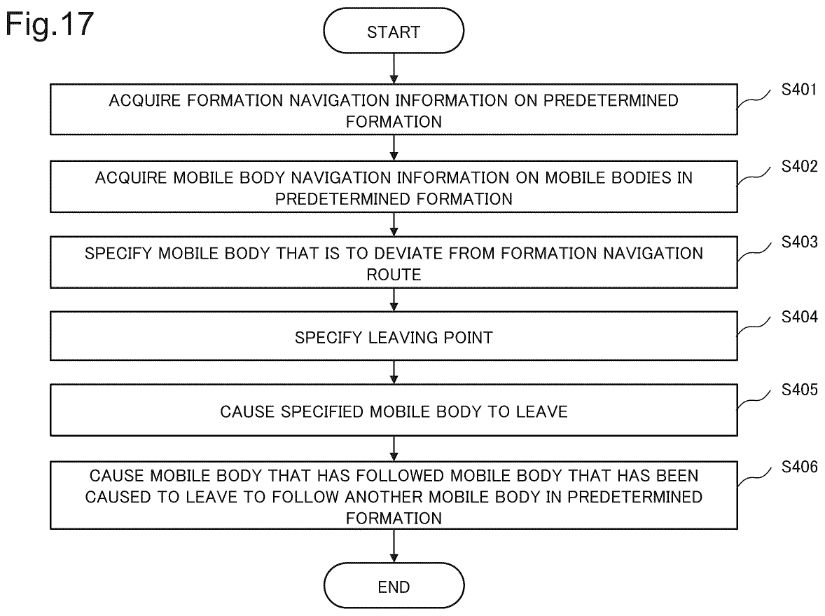

Next, a second example of an operation of the control device 102 will be described with reference to FIG. 17. In this operation example, an example of a case where one of mobile bodies flying in a predetermined formation leaves the formation will be described.

FIG. 17 is a flowchart explaining the second example of an operation of the control device 102. The acquisition unit 112 acquires the formation navigation information on the predetermined formation (S401). The acquisition unit 112 also acquires the mobile body navigation information on the mobile bodies in the predetermined formation (S402). The specifying unit 140 specifies a mobile body that is to deviate from the formation navigation route, based on the formation navigation information and the mobile body navigation information (S403). The specifying unit 140 also specifies the leaving point of the specified mobile body (S404).

When the formation has arrived at the leaving point, the control unit 132 causes the specified mobile body to leave the formation (S405). That is, the control unit 132 controls the specified mobile body in such a way as to navigate according to the individual navigation route of the specified mobile body. Then, the control unit 132 performs control to cause a mobile body that has followed the mobile body that has been caused to leave to follow another mobile body in the predetermined formation (S406). At this time, in a case where the mobile body that has been caused to leave has no follower mobile body, the control unit 132 may not perform the process in S406.

This operation example is merely an example. That is, the operation of the control device 102 is not limited to this example.

As described above, the control device 102 of the fourth example embodiment acquires the formation navigation information in which the navigation route of the formation to be navigated and the navigation time are associated with each other. The control device 102 also specifies a formation that will pass through the waiting point within predetermined time when a predetermined mobile body arrives at the waiting point, based on the formation navigation information. Then, in a case where a formation is specified, the control device 102 performs control to cause the predetermined mobile body to follow a mobile body of the specified formation at the waiting point.

This allows the control device 102 to cause the predetermined mobile body to join the navigating formation. In a case where the predetermined mobile body follows one mobile body in the formation, the control device 102 can cause the predetermined mobile body to turn off a function not necessary for following. Then, the control device 102 can suppress battery consumption of the predetermined mobile body.

The control device 102 acquires the formation navigation information including the formation navigation route that is a navigation route of a formation to be navigated and the mobile body navigation information including the individual navigation route that is a navigation route for each mobile body. The control device 102 also specifies a mobile body that is to deviate from the formation navigation route, among the mobile bodies navigating in a predetermined formation, based on the formation navigation information and the mobile body navigation information. Then, the control device 102 performs control to cause the specified mobile body to leave the predetermined formation and cause a mobile body that has followed the specified mobile body to follow another mobile body in the predetermined formation different from the specified mobile body.

This allows the control device 102 to cause the mobile body that is to deviate from the formation navigation route to leave the navigating formation while maintaining the formation.

### Fifth Example Embodiment

Next, a mobile body according to a fifth example embodiment will be described. In the fifth example embodiment, an example in which a mobile body autonomously performs various processes described in the first, second, third, and fourth example embodiments will be described. The description of content that is duplicate of that of the first, second, third, and fourth example embodiments will be partially omitted.

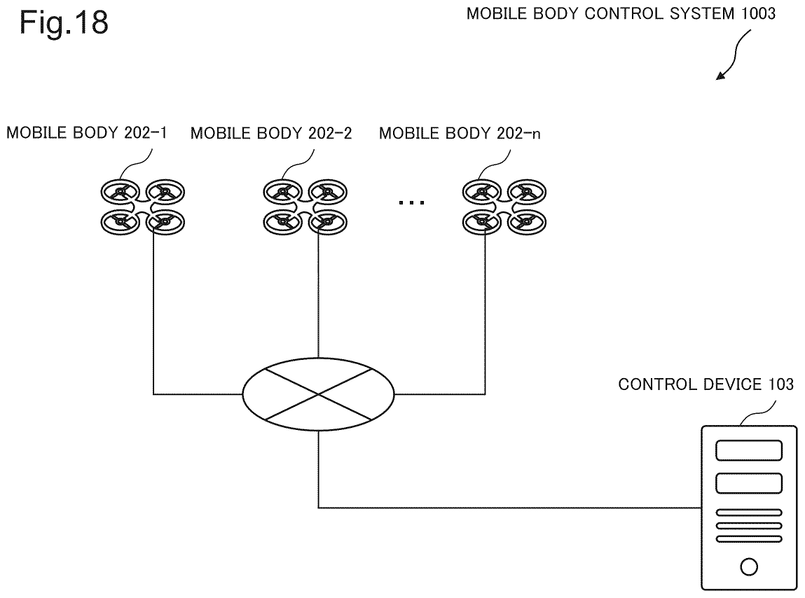

FIG. 18 is a diagram schematically illustrating an example of a configuration including mobile bodies 202. A mobile body control system 1003 includes at least the mobile body 202. In the example in FIG. 18, the mobile body control system 1003 includes a control device 103 and mobile bodies 202-1, 202-2, . . . , 202-3 (n is a natural number equal to or more than two). In a case where the mobile bodies 202-1, 202-2, . . . , and 202-n are not distinguished from each other, they will be simply referred to as “mobile bodies 202”. The mobile bodies 202 are interconnected to each other via a wireless or wired network in such a way that communication is allowed. The mobile bodies 202 are also connected to the control device 103 via a wireless or wired network in such a way that communication is allowed.

The control device 103 may have a configuration similar to that of any of the control devices 100, 101, and 102 described above. The mobile body 202 may have a configuration similar to that of any of the mobile bodies 200 and 201. Then, the control device 103 and the mobile body 202 may further perform an operation described below.

### Details of Mobile Body 202

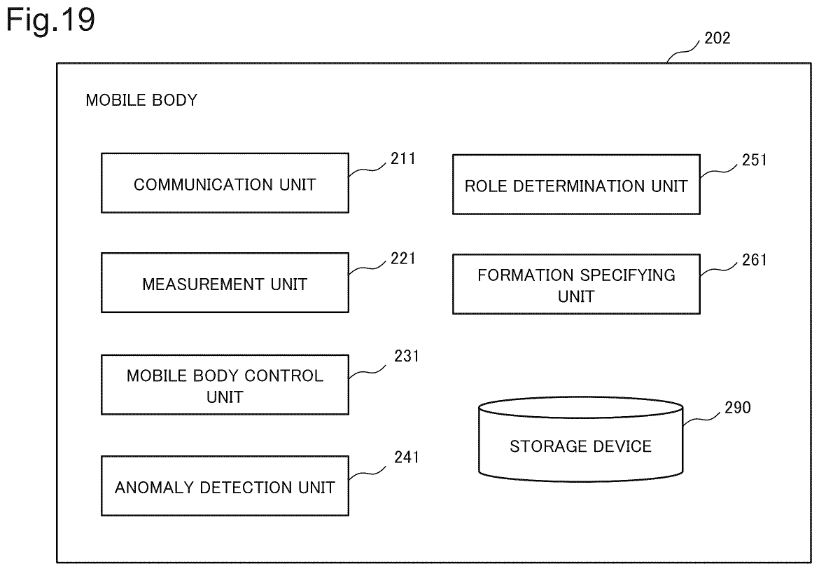

FIG. 19 is a block diagram illustrating an example of a configuration of the mobile body 202. The mobile body 202 includes a communication unit 211, a measurement unit 221, a mobile body control unit 231, an anomaly detection unit 241, a role determination unit 251, and a formation specifying unit 261. The mobile body 202 also includes a storage device 290.

The communication unit 211 acquires the function information from a plurality of mobile bodies 202. The communication unit 211 may be an example of the acquisition means. That is, the communication unit 211 may have the functions described for the acquisition units of the control devices of other example embodiments and modifications.

Specifically, the communication unit 211 acquires the function information from another mobile body forming a formation with its host mobile body. Information on another mobile body forming a formation with the host mobile body of the storage device 290 may be stored in advance in the storage device 290. Alternatively, the communication unit 211 may acquire information on another mobile body from the control device 103. For example, the host mobile body is assumed to be the mobile body 202-1. In this case, the communication unit 211 acquires information regarding the mobile bodies 202-2 and 202-3 from the control device 103, for example. This allows the mobile body 202-1 to specify that other mobile bodies forming a formation with the mobile body 202-1 are the mobile bodies 202-2 and 202-3.

The communication unit 211 may acquire the function information from the control device 103.

The role determination unit 251 determines the role of its host mobile body in accordance with a predetermined criterion. The role determination unit 251 may be an example of the determination means. That is, the role determination unit 251 may have the functions described for the determination units of the control devices of other example embodiments and modifications.

For example, information indicating the predetermined criterion is stored in the storage device 290. The role determination unit 251 determines the role of its host mobile body, based on the information indicating the predetermined criterion, which is stored in the storage device 290.

The predetermined criterion is assumed to be whether a function required for the role is equipped. For example, the lead aircraft is assumed to be required to have an imaging function, a position information positioning function, and a distance measurement function. In this case, the role determination unit 251 specifies one mobile body having the imaging function, the position information positioning function, and the distance measurement function, among the plurality of mobile bodies, based on the function information. In a case where the specified mobile body is the host mobile body of the role determination unit 251, the role determination unit 251 determines its host mobile body as a lead aircraft. In a case where the specified mobile body is not the host mobile body of the role determination unit 251, the role determination unit 251 determines its host mobile body as a wingman.

The predetermined criterion is assumed to be superiority or inferiority of performance of a function provided in the mobile body 202. In this case, the role determination unit 251 compares the function information. Then, the role determination unit 251 may specify one mobile body having a function with superior performance, among the plurality of mobile bodies 202. For example, the role determination unit 251 may specify a mobile body capable of imaging with a highest number of pixels or one mobile body with a highest zoomable magnification, among the plurality of mobile bodies 202. For example, the role determination unit 251 may specify a mobile body having a smallest error in the positioning function for the position information, among the plurality of mobile bodies 202. Then, as described above, in a case where the specified mobile body is the host mobile body of the role determination unit 251, the role determination unit 251 determines its host mobile body as a lead aircraft and, in a case where the specified mobile body is not its host mobile body, the role determination unit 251 determines its host mobile body as a wingman.

The approach for determining the roles is not limited to these examples. For example, the role determination unit 251 may specify at least one of the mobile bodies 202, based on whether the role has a required function. Then, in a case where a plurality of mobile bodies 202 is specified, the role determination unit 251 may specify one mobile body in accordance with superiority or inferiority of performance of the function.

The mobile body control unit 231 controls its host mobile body in accordance with the determined role. The mobile body control unit 231 may be an example of the control means. That is, the mobile body control unit 231 may have the functions described for the control units of the control devices of other example embodiments and modifications.

Specifically, in a case where the host mobile body of the mobile body control unit 231 is determined as a lead aircraft, the mobile body control unit 231 controls its host mobile body in such a way as to navigate the formation navigation route, based on the formation navigation information. The formation navigation information may be stored in advance in the storage device 290. Furthermore, the mobile body control unit 231 may take control in such a way as to fly on the formation navigation route while performing measurement for ensuring safety. At this time, the mobile body control unit 231 causes the measurement unit 221 to perform measurement for ensuring safety. In a case where the host mobile body of the mobile body control unit 231 is a lead aircraft, the mobile body control unit 231 may transmit information indicating the pattern of formation to the wingman mobile body via the communication unit 211.

In a case where the host mobile body of the mobile body control unit 231 is determined as a wingman, the mobile body control unit 231 takes control in such a way as to follow another mobile body in the formation (that is, the lead aircraft or another wingman). For example, the mobile body control unit 231 determines the position of its host mobile body in the pattern of formation. The information indicating the pattern of formation is included in, for example, the formation navigation information. The mobile body control unit 231 may acquire information indicating the pattern of formation from the lead aircraft mobile body. Here, the mobile body control unit 231 may transmit information indicating the determined position of its host mobile body to another wingman mobile body via the communication unit 211. That is, the mobile body control unit 231 determines a position other than the positions determined by the other wingmen, as the position of its host mobile body in the pattern of formation.

When the position of the mobile body 202 in the pattern of formation is determined, the mobile body control unit 231 determines the following target mobile body. Then, the mobile body control unit 231 takes control in such a way as to follow the following target mobile body, using the measurement function of the measurement unit 221.

In a case where the host mobile body of the mobile body control unit 231 is a wingman, the mobile body control unit 231 may turn off a function not necessary for following.

The mobile body 202 may perform control in accordance with a notification when an anomaly has occurred.

The anomaly detection unit 241 detects an anomaly that has occurred in the mobile body 202. Specifically, the anomaly detection unit 241 may detect an anomaly that has occurred in the measurement function. When detecting that an anomaly has occurred, the anomaly detection unit 241 transmits the anomaly notification to another mobile body via the communication unit 211.

The communication unit 211 receives the anomaly notification. When the communication unit 211 receives the anomaly notification from the lead aircraft mobile body, the role determination unit 251 verifies whether the role of its host mobile body needs to be changed. Specifically, the role determination unit 251 specifies one mobile body that meets a predetermined criterion, among the wingmen mobile bodies, based on the function information on the wingmen mobile bodies. Then, in a case where the specified mobile body is the host mobile body of the role determination unit 251, the role determination unit 251 verifies that the role of its host mobile body needs to be changed. That is, the role determination unit 251 newly determines its host mobile body as a lead aircraft. In a case where the specified mobile body is not the host mobile body of the role determination unit 251, the role determination unit 251 verifies that the role of its host mobile body does not need to be changed.

The host mobile body of the communication unit 211 is assumed to be the lead aircraft mobile body, and the communication unit 211 is assumed to have transmitted the anomaly notification. In this case, the role determination unit 251 newly determines its host mobile body as a wingman.

The mobile body control unit 231 controls its host mobile body in accordance with the newly determined role. For example, the positions of the mobile body newly determined as a lead aircraft and the mobile body newly determined as a wingman are switched. In a case where a function not necessary for following is turned off, the mobile body control unit 231 of the mobile body newly determined as a lead aircraft takes control in such a way that the function is turned on. The mobile body control unit 231 of the mobile body newly determined as a wingman may turn off a function not necessary for following.

The host mobile body the communication unit 211 is assumed to be a wingman mobile body, and the communication unit 211 is assumed to have transmitted the anomaly notification. In this case, the mobile body control unit 231 may withdraw its host mobile body in accordance with the content of the anomaly. For example, the mobile body control unit 231 may cause its host mobile body to leave the formation and withdraw to a withdrawal destination.

Furthermore, the mobile body 202 may, for example, join or leave the formation.

The formation specifying unit 261 specifies a predetermined formation in accordance with the situation. The formation specifying unit 261 may be an example of the specifying means. That is, the formation specifying unit 261 may have the functions described for the specifying units of the control devices of other example embodiments and modifications.

For example, the host mobile body is assumed to be a mobile body that does not form a formation. The formation specifying unit 261 estimates a time at which its host mobile body will arrive at the waiting point, based on the mobile body navigation information on its host mobile body. The formation specifying unit 261 also specifies a formation that will pass through the waiting point within predetermined time from the estimated time, among formations directed in the same direction as the traveling direction of its host mobile body, based on the formation navigation information. At this time, the formation navigation information may be stored in advance in the storage device 290, or may be information acquired from the control device 103 or another mobile body forming the formation. In a case where the formation navigation information is acquired from the control device 103 or another mobile body, the formation specifying unit 261 requests the formation navigation information from the control device 103 or another mobile body within a predetermined range via the communication unit 211. Then, the communication unit 211 acquires the formation navigation information from the control device 103 or the another mobile body.

In a case where a formation is specified by the formation specifying unit 261, the mobile body control unit 231 performs control to follow a mobile body of the specified formation at the waiting point.

For example, the host mobile body is assumed to be a mobile body forming a formation. The formation specifying unit 261 verifies whether its host mobile body is a mobile body that is to deviate from the formation navigation route, based on the formation navigation information and the mobile body navigation information on its host mobile body. In a case where the host mobile body of the formation specifying unit 261 is a mobile body that is to deviate from the formation navigation route, the formation specifying unit 261 further specifies the leaving point that is a point where its host mobile body leaves the formation.

In a case where the formation arrives at the leaving point, the mobile body control unit 231 controls its host mobile body in such a way as to navigate the individual navigation route. That is, the mobile body control unit 231 causes its host mobile body to leave. At this time, the mobile body control unit 231 transmits a leaving notification indicating leaving to another mobile body of the same formation via the communication unit 211.

The mobile body control unit 231 of the mobile body that has received the leaving notification takes control in such a way as to follow a mobile body different from the mobile body that has left.

### Operation Example 1 of Mobile Body 202

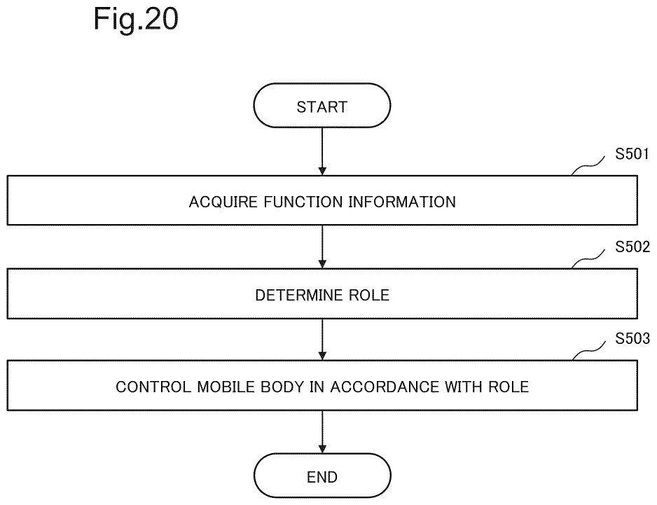

Next, a first example of an operation of the mobile body 202 will be described with reference to FIG. 20. In this operation example, an example in which a role in the formation is determined based on the function information and control is taken in accordance with the role will be described.

FIG. 20 is a flowchart explaining the first example of an operation of the mobile body 202. The communication unit 211 acquires the function information from a plurality of mobile bodies 202 (S501). For example, the communication unit 211 acquires the function information from another mobile body forming a formation with its host mobile body. The role determination unit 251 determines the role of its host mobile body in accordance with a predetermined criterion (S502). For example, the role determination unit 251 specifies one mobile body that meets the predetermined criterion, among the plurality of mobile bodies, based on the function information. In a case where the specified mobile body is the host mobile body of the role determination unit 251, the role determination unit 251 determines its host mobile body as a lead aircraft. In a case where the specified mobile body is not the host mobile body of the role determination unit 251, the role determination unit 251 determines its host mobile body as a wingman.

Then, the mobile body control unit 231 controls its host mobile body in accordance with the determined role (S503). For example, in a case where the host mobile body of the mobile body control unit 231 is determined as a lead aircraft, the mobile body control unit 231 controls its host mobile body in such a way as to navigate the formation navigation route, based on the formation navigation information. In a case where the host mobile body of the mobile body control unit 231 is determined as a wingman, the mobile body control unit 231 takes control in such a way as to follow another mobile body in the formation (that is, the lead aircraft or another wingman).

### Operation Example 2 of Mobile Body 202

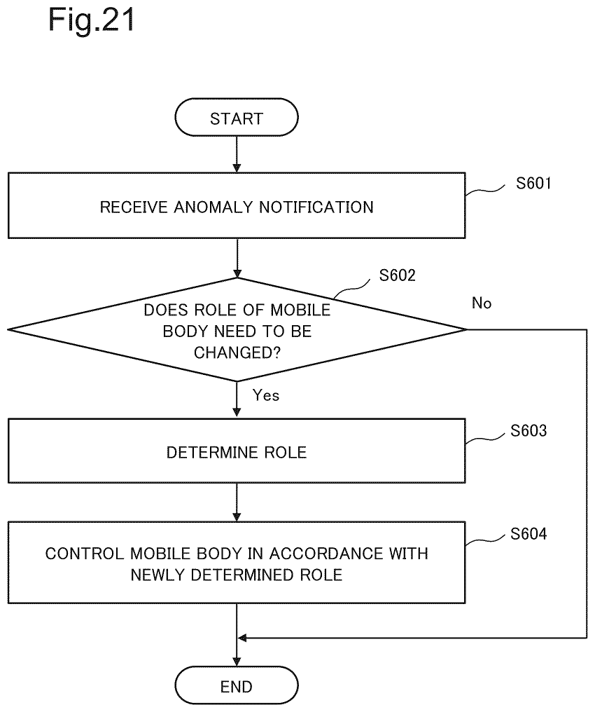

Next, a second example of an operation of the mobile body 202 will be described with reference to FIG. 21. In this operation example, a control example in accordance with a notification when an anomaly has occurred will be described. In this operation example, an example of a case where the anomaly notification is transmitted to the host mobile body will also be described.

FIG. 21 is a flowchart explaining the second example of an operation of the mobile body 202. The communication unit 211 receives the anomaly notification (S601). The role determination unit 251 verifies whether the role of its host mobile body needs to be changed. For example, when the anomaly notification is transmitted from the lead aircraft mobile body, the role determination unit 251 specifies one mobile body that meets a predetermined criterion. Then, in a case where the specified mobile body is the host mobile body of the role determination unit 251, the role determination unit 251 verifies that the role of its host mobile body needs to be changed.

In a case where the role of the host mobile body of the role determination unit 251 needs to be changed (“Yes” in S602), the role determination unit 251 newly determines the role (S603). For example, the role determination unit 251 newly determines its host mobile body as a lead aircraft. Then, the mobile body control unit 231 controls its host mobile body in accordance with the newly determined role (S604). In a case where the role of the mobile body 202 does not need to be changed (“No” in S602), the mobile body 202 may end the process.

### Operation Example 3 of Mobile Body 202

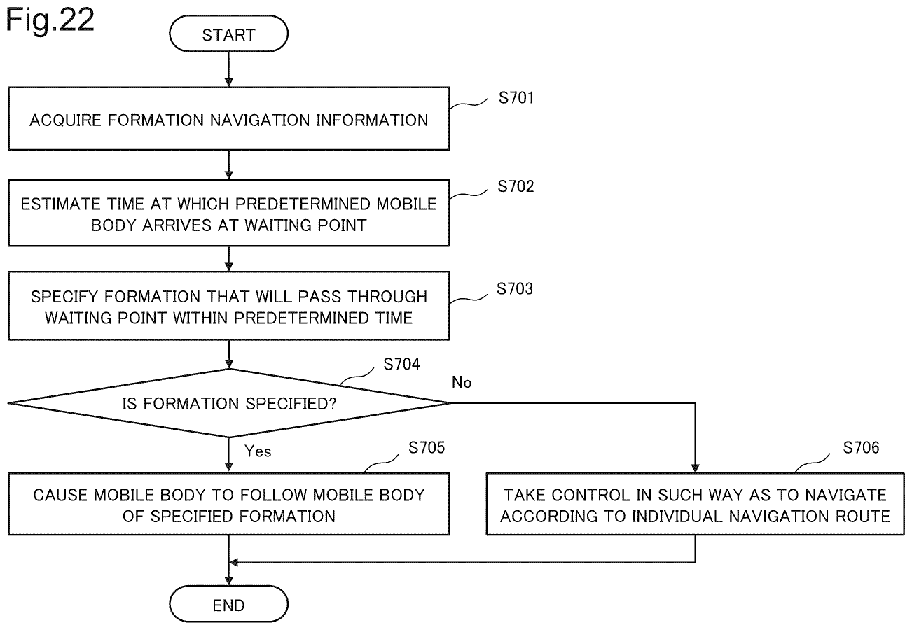

Next, a third example of an operation of the mobile body 202 will be described with reference to FIG. 22. In this operation example, an example of a case where the mobile body 202 that does not form a formation joins a formation will be described.

FIG. 22 is a flowchart explaining the third example of an operation of the mobile body 202. The communication unit 211 acquires the formation navigation information (S701). The formation specifying unit 261 estimates a time at which its host mobile body will arrive at the waiting point, based on the mobile body navigation information on its host mobile body (S702). Then, the formation specifying unit 261 specifies a formation that will pass through the waiting point within predetermined time from the estimated time (S703). Specifically, the formation specifying unit 261 specifies a formation that will pass through the waiting point within predetermined time from the estimated time, among formations directed in the same direction as the traveling direction of its host mobile body, based on the formation navigation information.

In a case where a formation is specified (“Yes” in S704), the mobile body control unit 231 performs control to follow a mobile body of the specified formation at the waiting point (S705). At this time, in a case where the specified formation has time until arriving at the waiting point, the mobile body control unit 231 may cause the predetermined mobile body to stand by until the formation arrives at the waiting point.

In a case where no formation is specified (“No” in S704), the mobile body control unit 231 controls its host mobile body in such a way as to navigate according to the individual navigation route (S706).

### Operation Example 4 of Mobile Body 202

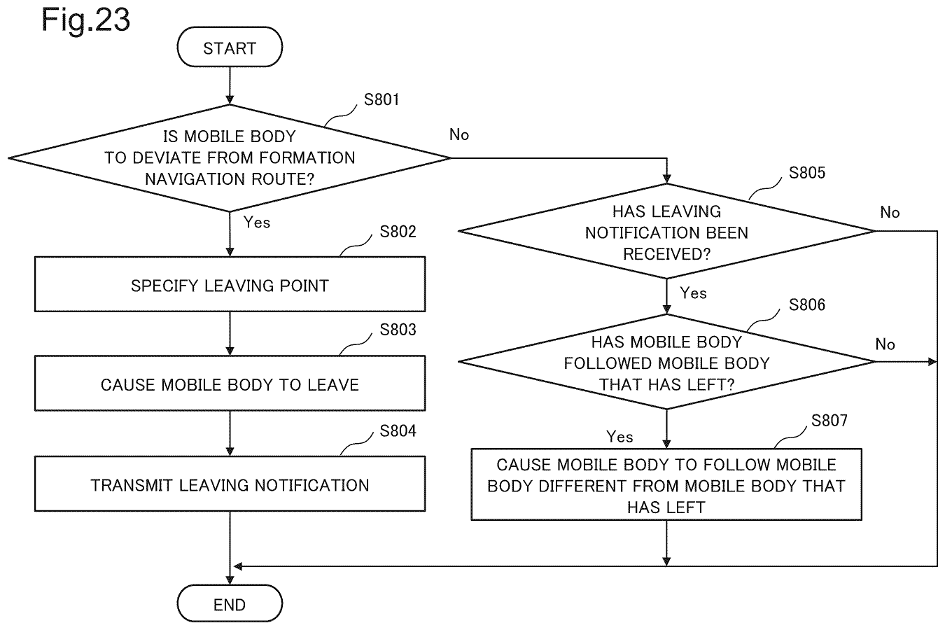

Next, a fourth example of an operation of the mobile body 202 will be described with reference to FIG. 23. In this operation example, an example of a case where the mobile body 202 forming a formation leaves the formation will be described.

FIG. 23 is a flowchart explaining the fourth example of an operation of the mobile body 202. The formation specifying unit 261 verifies whether its host mobile body is a mobile body that is to deviate from the formation navigation route, based on the formation navigation information and the mobile body navigation information on its host mobile body. In a case where the host mobile body of the formation specifying unit 261 is a mobile body that is to deviate from the formation navigation route (“Yes” in S801), the formation specifying unit 261 specifies the leaving point of its host mobile body (S802).

The mobile body control unit 231 causes its host mobile body to leave the formation when the formation arrives at the leaving point (S803). That is, the mobile body control unit 231 controls its host mobile body in such a way as to navigate according to the individual navigation route. Then, the communication unit 211 transmits the leaving notification (S804).

In a case where the mobile body 202 is not a mobile body that is to deviate (“No” in S801), the mobile body 202 performs the following operation. In particular, in a case where the leaving notification has been received (“Yes” in S805) and the host mobile body of the mobile body control unit 231 has followed the mobile body that has left (“Yes” in S806), the mobile body control unit 231 takes control in such a way as to follow a mobile body different from the mobile body that has left (S807).

All the operation examples are merely examples. That is, the operation of the mobile body 202 is not limited to these examples.

As described above, when a plurality of mobile bodies forms a formation, the mobile body 202 of the fifth example embodiment acquires the function information indicating measurement functions provided in each of the plurality of mobile bodies. The mobile body 202 determines the mobile body 202 itself as a lead aircraft in a case where the mobile body 202 has a measurement function that meets a predetermined criterion and determines the mobile body 202 itself as a wingman in a case where the mobile body 202 does not have a measurement function that meets the predetermined criterion, based on the function information. Then, the mobile body 202 controls the mobile body 202 itself in accordance with the determined role.

This allows the mobile body 202 to achieve effects similar to the effects described in other example embodiments. That is, the mobile body 202 can appropriately assign the role, based on the function information indicating the measurement function.

### Third Modification

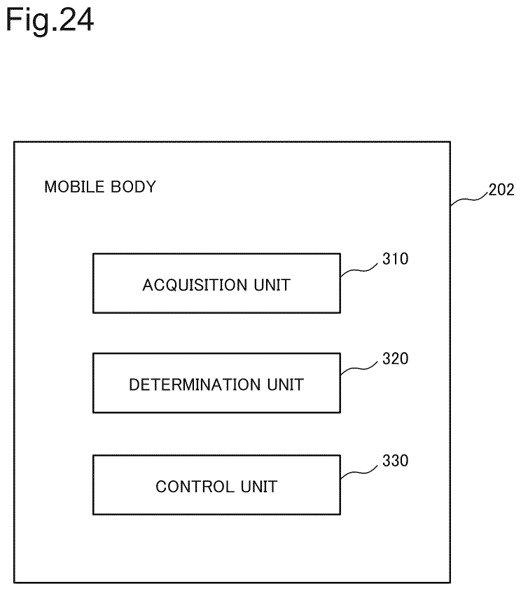

The mobile body 202 can also be described as follows. FIG. 24 is a block diagram illustrating an example of a functional configuration of the mobile body 202. The mobile body 202 includes an acquisition unit 310, a determination unit 320, and a control unit 330.

The acquisition unit 310 acquires the function information indicating measurement functions provided in each of a plurality of mobile bodies. The acquisition unit 310 may be an example of the acquisition means. The determination unit 320 determines its host mobile body as a lead aircraft in a case where its host mobile body has a measurement function that meets a predetermined criterion and determines its host mobile body as a wingman in a case where its host mobile body does not have a measurement function that meets the predetermined criterion, based on the function information. The determination unit 320 may be an example of the determination means. The control unit 330 controls its host mobile body in accordance with the determined role. The control unit 330 may be an example of the control means.

### Hardware Configuration Example of Mobile Body Control System

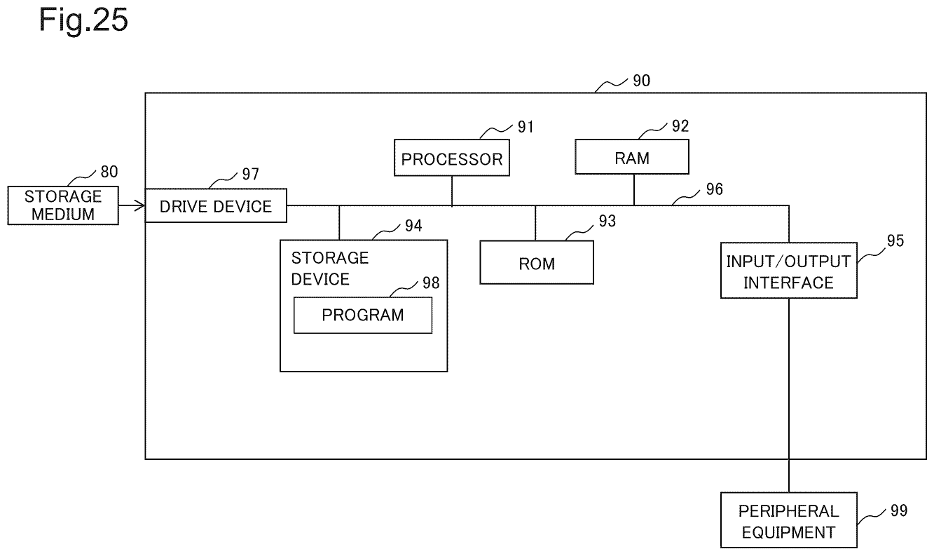

Hardware constituting the control devices and the mobile bodies of the above first, second, third, fourth, and fifth example embodiments will be described. FIG. 25 is a block diagram illustrating an example of a hardware configuration of a computer device constituting the control devices or the mobile bodies according to each example embodiment. In a computer device 90, the control devices, the mobile bodies, and the control method described in each example embodiment and each modification are implemented. For example, each of the control devices, the mobile bodies, and the like described in each example embodiment and each modification may have the hardware configuration illustrated in FIG. 25.

As illustrated in FIG. 25, the computer device 90 includes a processor 91, a random access memory (RAM) 92, a read only memory (ROM) 93, a storage device 94, an input/output interface 95, a bus 96, and a drive device 97. The control device and the mobile body may be implemented by a plurality of electric circuits.

The storage device 94 stores a program (computer program) 98. The processor 91 executes the program 98 of the mobile body control system, using the RAM 92. Specifically, for example, the program 98 includes a program that causes a computer to execute the processes illustrated in FIGS. 3, 7, 10, 16, 17, 20, 21, 22, 23, and 24. The function of each component of the mobile body control system is implemented in response to the processor 91 executing the program 98. The program 98 may be stored in the ROM 93. The program 98 may be recorded in a storage medium 80 and read using the drive device 97, or may be transmitted to the computer device 90 from an external device (not illustrated) via a network (not illustrated).

The input/output interface 95 exchanges data with peripheral equipment (such as a keyboard, a mouse, or a display device) 99. The input/output interface 95 functions as a means for acquiring or outputting data. The bus 96 connects the components with each other.

The method for implementing the control device and the mobile body has a variety of modifications. For example, each component included in the control device and the mobile body can be implemented as a dedicated device. The control device and the mobile body each can be implemented based on a combination of a plurality of devices.

A processing method of causing a storage medium to record a program for implementing each component in the functions of each example embodiment, reading the program recorded in the storage medium as a code, and executing the program in a computer is also included in the scope of each example embodiment. That is, a computer-readable storage medium is also included in the scope of each example embodiment. The storage medium recording the program described above and the program itself are also included in each example embodiment.

The storage medium is, for example, a floppy (registered trademark) disk, a hard disk, an optical disc, a magneto-optical disk, a compact disc (CD)-ROM, a magnetic tape, a nonvolatile memory card, or a ROM, but is not limited to these examples. In addition, the program recorded in the storage medium is not limited to a program that executes a process by itself, and programs that operate on an operating system (OS) to execute a process in cooperation with other software and functions of an extension board are also included in the scope of each example embodiment.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

The above-described example embodiments and modifications can be appropriately combined with each other.

Some or all of the above example embodiments may be described as the following Supplementary Notes, but are not limited to the following.

### Supplementary Note 1

A control device including:
an acquisition means for acquiring function information indicating measurement functions provided in each of a plurality of mobile bodies;
a determination means for determining a role of one mobile body having a measurement function meeting a predetermined criterion, among the plurality of mobile bodies, as a lead aircraft, and determining roles of other mobile bodies as wingmen, based on the function information; and
a control means for performing control to cause the plurality of mobile bodies to form a formation in accordance with the determined roles.

### Supplementary Note 2

The control device according to Supplementary Note 1, in which
the control means performs control to cause the mobile bodies determined as the wingmen to follow a lead aircraft or another wingman mobile body, and to turn off a function not necessary for following.

### Supplementary Note 3

The control device according to Supplementary Note 1 or 2, in which
the acquisition means acquires a notification indicating occurrence of an anomaly from a lead aircraft mobile body flying in formation, and
the determination means:
newly determines the role of the lead aircraft mobile body as a wingman; and
determines the role of one mobile body having a measurement function meeting the predetermined criterion, among the wingmen mobile bodies flying in formation, as the lead aircraft, based on the function information.

### Supplementary Note 4

The control device according to Supplementary Note 3, in which
in a case where the notification indicates the anomaly in a measurement function relating to position information,
the control means performs control to cause the mobile body newly determined as the wingman to follow the lead aircraft or another wingman mobile body, using an imaging function.

### Supplementary Note 5

The control device according to Supplementary Note 3 or 4, in which
in a case where the notification indicates the anomaly relating to a remaining capacity of a battery,
the control means controls the mobile body newly determined as the wingman to turn off a function not necessary for following another mobile body.

### Supplementary Note 6

The control device according to any one of Supplementary Notes 1 to 5, further including
a specifying means, in which
the acquisition means acquires formation navigation information in which a navigation route of a formation to be navigated and a navigation time are associated with each other,
in a case where a predetermined mobile body different from the plurality of mobile bodies arrives at a waiting point, the specifying means specifies a formation that will pass through the waiting point within predetermined time based on the formation navigation information, and
in a case where the formation is specified by the specifying means, the control means performs control to cause the predetermined mobile body to follow a mobile body of the specified formation at the waiting point.

### Supplementary Note 7

The control device according to any one of Supplementary Notes 1 to 5, further including
a specifying means, in which
the acquisition means acquires:
formation navigation information including a formation navigation route that is a navigation route of a formation to be navigated; and
mobile body navigation information including an individual navigation route that is a navigation route for each mobile body,
the specifying means specifies a mobile body that is to deviate from the formation navigation route, among mobile bodies that navigate in a predetermined formation, based on the formation navigation information and the mobile body navigation information, and
the control means:
causes the specified mobile body to leave the predetermined formation; and
performs control to cause a mobile body that has followed the specified mobile body to follow another mobile body in the predetermined formation different from the specified mobile body.

### Supplementary Note 8

The control device according to any one of Supplementary Notes 1 to 7, in which
the acquisition means acquires weather information on a navigation route of the plurality of mobile bodies, and
the control means:
specifies a pattern of formation from the acquired weather information, based on a learning model in which a relationship between the weather information, battery consumption of the mobile bodies, and the pattern of formation has been learned; and
controls the plurality of mobile bodies in such a way as to navigate in the specified pattern of formation.

### Supplementary Note 9

The control device according to any one of Supplementary Notes 1 to 8, in which
a mark is attached to each of the plurality of mobile bodies, and
the control means causes a wingman mobile body to follow another mobile body by causing the wingman mobile body to image the mark.

### Supplementary Note 10

The control device according to any one of Supplementary Notes 3 to 5, in which
the control means switches a newly determined lead aircraft mobile body and the newly determined wingman mobile body.

### Supplementary Note 11

A mobile body including:
in a case where the plurality of mobile bodies forms a formation,
an acquisition means for acquiring function information indicating measurement functions provided in each of a plurality of mobile bodies
a determination means for determining the mobile body as a lead aircraft when the mobile body has a measurement function meeting a predetermined criterion, and determining the mobile body as a wingman when the mobile body does not have a measurement function meeting the predetermined criterion, based on the function information; and
a control means for controlling the mobile body in accordance with a determined role.

### Supplementary Note 12

The mobile body according to Supplementary Note 11, in which
in a case where determined as the wingman by the determination means,
the control means performs control to follow a lead aircraft or another wingman mobile body, and to turn off a function not necessary for following.

### Supplementary Note 13

The mobile body according to Supplementary Note 11 or 12, in which
in a case where the mobile body is the wingman and is flying in formation,
the acquisition means acquires a notification indicating occurrence of an anomaly from a lead aircraft mobile body, and
the determination means determines the mobile body as the lead aircraft or the wingman, based on the function information on the mobile body and another wingman mobile body.

### Supplementary Note 14

The mobile body according to Supplementary Note 11, further including
an anomaly detection means for detecting an anomaly that has occurred in a measurement function of the mobile body, in which
the anomaly detection means transmits a notification indicating occurrence of the anomaly to another mobile body forming a formation with the mobile body when detecting the anomaly.

### Supplementary Note 15

The mobile body according to Supplementary Note 14, in which
in a case where the mobile body is the lead aircraft and is flying in a formation, and the anomaly detection means detects the anomaly,
the determination means newly determines the mobile body as the wingman, and
the control means performs control to follow another mobile body forming the formation with the mobile body.

### Supplementary Note 16

The mobile body according to Supplementary Note 15, in which
in a case where the anomaly detection means detects the anomaly in a measurement function relating to position information,
the control means performs control to follow another mobile body forming the formation with the mobile body, using an imaging function.

### Supplementary Note 17

The mobile body according to Supplementary Note 15 or 16, in which
in a case where the anomaly detection means detects the anomaly relating to a remaining capacity of a battery,
the control means performs control to turn off a function not necessary for following another mobile body forming the formation with the mobile body.

### Supplementary Note 18

The mobile body according to Supplementary Note 11, further including
a specifying means, in which
in a case where the mobile body is not flying in formation,
the acquisition means acquires formation navigation information in which a navigation route of a formation to be navigated and a navigation time are associated with each other,
the specifying means specifies a formation that will pass through a waiting point within predetermined time when the mobile body arrives at the waiting point, based on the formation navigation information, and
in a case where the formation is specified by the specifying means, the control means performs control to follow a mobile body of the specified formation at the waiting point.

### Supplementary Note 19

The mobile body according to Supplementary Note 11, further including
a specifying means, in which
when the mobile body is flying in a predetermined formation,
the acquisition means acquires:
formation navigation information including a formation navigation route that is a navigation route of a formation to be navigated; and
mobile body navigation information including an individual navigation route that is a navigation route for each mobile body,
the specifying means specifies whether the mobile body is a mobile body that is to deviate from the formation navigation route, based on the formation navigation information and the mobile body navigation information, and
the control means causes the mobile body to leave the predetermined formation.

### Supplementary Note 20

A control method including:
acquiring function information indicating measurement functions provided in each of a plurality of mobile bodies;
determining a role of one mobile body having a measurement function meeting a predetermined criterion, among the plurality of mobile bodies, as a lead aircraft, and determining roles of other mobile bodies as wingmen, based on the function information; and
performing control to cause the plurality of mobile bodies to form a formation in accordance with the determined roles.

### Supplementary Note 21

A computer-readable storage medium storing a program for causing a computer to execute:
when acquiring function information indicating measurement functions provided in each of a plurality of mobile bodies,
a process of determining a role of one mobile body having a measurement function that meeting a predetermined criterion, among the plurality of mobile bodies, as a lead aircraft, and determining roles of other mobile bodies as wingmen, based on the function information; and
a process of performing control to cause the plurality of mobile bodies to form a formation in accordance with the determined roles.

This application is based upon and claims the benefit of priority from Japanese Patent Application No. 2023-040582, filed on Mar. 15, 2023, the disclosure of which is incorporated herein in its entirety by reference.

### Reference Signs List

100, 101, 102, 103 control device
110, 111, 112, 310 acquisition unit
120, 121, 320 determination unit
130, 131, 132, 330 control unit
140 specifying unit
190, 290 storage device
200 mobile body
210, 211 communication unit
220, 221 measurement unit
230, 231 mobile body control unit
240, 241 anomaly detection unit
251 role determination unit
261 formation specifying unit

What is claimed is:

1. A control device comprising:
a memory; and
at least one processor coupled to the memory
the at least one processor performing operations to:
acquire function information indicating measurement functions provided in each of a plurality of mobile bodies;
determine a role of one mobile body having a measurement function meeting a predetermined criterion, among the plurality of mobile bodies, as a lead aircraft, and determine roles of other mobile bodies as wingmen, based on the function information; and
perform control to cause the plurality of mobile bodies to form a formation in accordance with the determined roles.

2. The control device according to claim 1, wherein the at least one processor further performs operation to:
perform control to cause the mobile bodies determined as the wingmen to follow a lead aircraft or another wingman mobile body, and to turn off a function not necessary for following.

3. The control device according to claim 1, wherein the at least one processor further performs operation to:
acquire a notification indicating occurrence of an anomaly from a lead aircraft mobile body flying in formation,
newly determine the role of the lead aircraft mobile body as a wingman, and
determine the role of one mobile body having a measurement function meeting the predetermined criterion, among the wingmen mobile bodies flying in formation, as the lead aircraft, based on the function information.

4. The control device according to claim 3, wherein the at least one processor further performs operation to:
in a case where the notification indicates the anomaly in a measurement function relating to position information,
perform control to cause the mobile body newly determined as the wingman to follow the lead aircraft or another wingman mobile body, using an imaging function.

5. The control device according to claim 3, wherein the at least one processor further performs operation to:
in a case where the notification indicates the anomaly relating to a remaining capacity of a battery,
control the mobile body newly determined as the wingman to turn off a function not necessary for following another mobile body.

6. The control device according to claim 1, wherein the at least one processor further performs operation to:
acquire formation navigation information in which a navigation route of a formation to be navigated and a navigation time are associated with each other,
in a case where a predetermined mobile body different from the plurality of mobile bodies arrives at a waiting point, specify a formation that will pass through the waiting point within predetermined time based on the formation navigation information, and
in a case where the formation is specified, perform control to cause the predetermined mobile body to follow a mobile body of the specified formation at the waiting point.

7. The control device according to claim 1, wherein the at least one processor further performs operation to:
acquire:
formation navigation information including a formation navigation route that is a navigation route of a formation to be navigated; and
mobile body navigation information including an individual navigation route that is a navigation route for each mobile body,
specify a mobile body that is to deviate from the formation navigation route, among mobile bodies that navigate in a predetermined formation, based on the formation navigation information and the mobile body navigation information,
cause the specified mobile body to leave the predetermined formation, and
perform control to cause a mobile body that has followed the specified mobile body to follow another mobile body in the predetermined formation different from the specified mobile body.

8. The control device according to claim 1, wherein the at least one processor further performs operation to:
acquire weather information on a navigation route of the plurality of mobile bodies, and
specify a pattern of formation from the acquired weather information, based on a learning model in which a relationship between the weather information, battery consumption of the mobile bodies, and the pattern of formation has been learned, and
control the plurality of mobile bodies in such a way as to navigate in the specified pattern of formation.

9. The control device according to claim 1, wherein
a mark is attached to each of the plurality of mobile bodies,
wherein the at least one processor further performs operation to
cause a wingman mobile body to follow another mobile body by causing the wingman mobile body to image the mark.

10. The control device according to claim 3, wherein the at least one processor further performs operation to:
switch a newly determined lead aircraft mobile body and the newly determined wingman mobile body.

11-18. (canceled)

19. A control method comprising:
acquiring function information indicating measurement functions provided in each of a plurality of mobile bodies;
determining a role of one mobile body having a measurement function meeting a predetermined criterion, among the plurality of mobile bodies, as a lead aircraft, and determining roles of other mobile bodies as wingmen, based on the function information; and
performing control to cause the plurality of mobile bodies to form a formation in accordance with the determined roles.

20. A non-transitory computer-readable storage medium storing a program for causing a computer to execute:
acquiring function information indicating measurement functions provided in each of a plurality of mobile bodies,
determining a role of one mobile body having a measurement function meeting a predetermined criterion, among the plurality of mobile bodies, as a lead aircraft, and determining roles of other mobile bodies as wingmen, based on the function information; and
performing control to cause the plurality of mobile bodies to form a formation in accordance with the determined roles.
